SEQUENCE LISTING (12 sequences)

SEQ ID NO: 1 - DNA, 1378 bp, Bacillus pumilus
gagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgcaacacccgaagtcggtgaggtaacc

SEQ ID NO: 2 - DNA, 1399 bp, Bacillus subtilis
  modified_base (196)..(197): a, c, t, g, unknown or other
gcagtcgagcggacagatgggagcttgctccctgatgttagcggcggacgggtgagtaacacgtgggtaacctgcctgtaagactgggataactccgggaaaccggggctaataccggatgcttgtttgaaccgcatggttcaaacataaaaggtggcttcggctaccacttacagatggacccgcggcgcattanntagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacc

SEQ ID NO: 3 - DNA, 1202 bp, Bacillus subtilis
tagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacc

SEQ ID NO: 4 - DNA, 1440 bp, Bacillus pumilus
gtgcgggtgctataatgcagtcgagcggacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgcaacacccgaagtcggtgaggtaacctttatggagccagccgccgaacgttc

SEQ ID NO: 5 - DNA, 1448 bp, Bacillus subtilis
tggcggcgtgctataatgcagtcgagcggacagatgggagcttgctccctgatgttagcggcggacgggtgagtaacacgtgggtaacctgcctgtaagactgggataactccgggaaaccggggctaataccggatgcttgtttgaaccgcatggttcaaacataaaaggtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttaggagccagccgccgaagggacagagag

SEQ ID NO: 6 - DNA, 1522 bp, Bacillus subtilis
ctggctcaggacgaacgctggcggcgtgcctaatacatgcaagtcgagcggacagatgggagcttgctccctgatgttagcggcggacgggtgagtaacacgtgggtaacctgcctgtaagactgggataactccgggaaaccggggctaataccggatggttgtttgaaccgcatggttcaaacataaaaggtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttaggagccagccgccgaaggtgggacagatgattggggtgaagtcgtaacaaggtagccgtatcggaaggtgcggttggat

SEQ ID NO: 7 - DNA, 136 bp, Artificial Sequence
  Description of Artificial Sequence Synthetic polynucleotide
ggttctccgcatcaaactatccggcgaacttgccgggtatttgggacgcccactggggatacctggcgaagaaggacattgccccggttctcgtgggtgagttcggtacgaagttcgagacgacgagcgacaagca

SEQ ID NO: 8 - DNA, 2241 bp, Clavibacter michiganensis
gtgcgaaaggcgtctgtggaagtggttttcagtgcggccggatggcttccctacgatccttatatgacatttcgccaagttcgtgcatccttagtgcttcggctcgtccttctccttgcgttggtggtcggcaccacgtccgccgcattcgctgcgcctgtctcagccgccaccgtagcggggcccgttgcggcggcctcatcgcctggatggctgcatacggcgggcgggaagatcgtcaccgcctccggtgctccgtacacgatccgtggcatcgcttggtttggcatggagacgtcgtcgtgcgcgccgcatggcctggacaccatcaccctcgcgggcggtatgcagcacatcaagcagatggggttcacgaccgtgcggttgcccttctcgaaccagtgcctcgccgcgtccggcgtcacgggtgtcagtgcggacccgtcactcgccgggctcacgccgctgcaggtcatggaccacgtcgtcgcgtcggcgaagagcgccggtcttgacgtgatcctcgaccagcaccggccggactcgggcggccagtctgagctctggtacacatcgcagtatccggagtcgcggtggatctccgactggaggatgctcgcaaagcgctacgcgtccgaccccgccgtcatcggtgtcgacctgcacaacgagccgcacggtgcggcgacctggggtaccggggcggccaccactgactggcgggcagcggccgagcgtggcgggaatgcggtcctcgccgagaacccgaacctcctcgtgctcgtggagggcatcgaccacgaggccgacggatctggcacctggtggggcggcgcgctcgggttggtaggcaatgcacctgtgcggctgtcggtcgcgaatcgcgtcgtctactccccgcatgactacccctcgaccatttacggccagtcatggttctccgcatcaaactatccggcgaacttgccgggtatttgggacgcccactggggatacctggcgaagaaggacattgccccggttctcgtgggtgagttcggtacgaagttcgagacgacgagcgacaagcagtggctcaacaccctcgttggatatctgtcgagcacggggattagctcgtcgttctgggccttcaacccgaatagtggcgacaccggcggtatcgtgaagtccgactgggtgaccccggagcaggcgaagctcgacgccctggcgccgatcttgcacccgtcgcccgggtcgggtccgggatccggcggatccgggtctcagccagcgccgcagcccgatccggcgaacccgggcgctgtatcagcgaagtggcagcctggcagctcctgggcatcgggctacgtagcgaacatcgacgtcaccgcgacagccgctgtcacgggatggaccgtctcatgggccagccccggaaccacccgcgtcgtcaacagttggggcatgcgctgcagcgtcgcctccggcaccgtgagctgcaccggcacggactgggcgagcaagctcgccgccggccagaccgttcacgtcggcctacaggcgtcgggtggcccggctccctcttcaccacgactcaccgctacagcggccgcggtgccgcctgcccagcccacaccgcccgctcggcccacgacgcatggccgtgccacgcactactcgctcggccagggcaacacgatcgcgaacggcaactgctccatgccggctgtccctgcagaccgaatgtacgttgcggtcagcagccccgagtacagcggtgccgccgcgtgcggcaccttcctcgacgtcactggccccaagggcaccgtccgcgttcaggtcgctgaccagtgccatgggtgcgaggtcggacatctcgatctgagcgaggaagcgttccgcgccctcggcgacttcaatgccggcatcatcccgatcagctacgtcaccgtccgggatccggccgggcctaccgtcgccatccgagtcaaagaaggctcatcccgctggtgggcaggtctgcaggtcctgaacgccggcaaccgcattgaccgtgtcgaaatccaggccgggagacagtggctgcccctcactcgcaccgactacgggtactgggtgacgccgtccccgattcaggacggccccctgaccgtgaaggtgaccgaccagtatggtcgcgcggtcgtgctccccggcctccgcatggcacccggggagatccagcgcacggcctcccgcttctaccctgtgcactga

SEQ ID NO: 9 - DNA, 20 bp, Artificial Sequence
  Description of Artificial Sequence Synthetic primer
agagtttgatcmtggctcag

SEQ ID NO: 10 - DNA, 22 bp, Artificial Sequence
  Description of Artificial Sequence Synthetic primer
tacggytaccttgttacgactt

SEQ ID NO: 11 - DNA, 22 bp, Artificial Sequence
  Description of Artificial Sequence Synthetic primer
ggttctccgcatcaaactatcc

SEQ ID NO: 12 - DNA, 15 bp, Artificial Sequence
  Description of Artificial Sequence Synthetic primer
tgcttgtcgctcgtc

(19) United States
(12) Patent Application Publication
(10) Pub. No.: US 2022/0369646 A1
(43) Pub. Date: Nov. 24, 2022

(54) METHODS AND COMPOSITIONS FOR BIOPROTECTION OF TOMATOES FROM CLAVIBACTER MICHIGANENSIS SUBSP. MICHIGANENSIS

(71) Applicant: THE ROYAL INSTITUTION FOR THE ADVANCEMENT OF LEARNING/MCGILL UNIVERSITY, Montréal (CA)

(72) Inventors: Fazli MABOOD, Centennial, CO (US); Margaret Ann BYWATER-EKEGARD, Centennial, CO (US); David Hernando Sanchez LLANO, Centennial, CO (US); Donald Lawrence SMITH, Montreal, CA (US)

(21) Appl. No.: 17/279,820

(22) PCT Filed: Sep. 27, 2019
(86) PCT No.: PCT/US19/53650

§ 371 Date: Mar. 25, 2021

Related U.S. Application Data
(60) Provisional application No. 62/737,765, filed on Sep. 27, 2018.
(60) Provisional application No. 62/744,110, filed on Oct. 10, 2018.

(51) Int. Cl. A01N 63/22; A01P 1/00

(52) U.S. Cl. CPC A01N 63/22; A01P 1/00

(57) ABSTRACT

The present invention relates to compositions having antimicrobial activity against Clavibacter michiganensis subsp michiganensis “(Cmm”). Further provided herein are methods of making and using the antimicrobial compositions to protect and treat tomatoes from Cmm infections.

### 1. BACKGROUND

Clavibacter michiganensis subsp. michiganensis (“Cmm”) is a Gram-positive, aerobic plant pathogenic bacterium and causes wilt and canker disease on tomatoes, which is one of the most destructive and economically significant diseases of tomatoes. Cmm can infect tomato plants via several different infection routes. The primary inoculum sources are usually infected seeds, transplants, residual plant matter in the soil and operating tools and equipment. Secondary infection of the plant is caused by transmission of the pathogen through roots, leaves and cultural practices. In particular, infected seeds have been considered as the major source of disease outbreaks and Cmm dissemination. Even a low transmission rate from seed to seedlings can cause a serious disease epidemic under favourable conditions. As a result of severe yield and economic losses, Cmm is considered a quarantine pathogen.

Tomato plants infected with Cmm show a variety of symptoms. Pathogen entering the plant through trichomes, wounds or natural openings such as stomata and hydathodes leads to local infection, and initial symptoms appear as marginal necrosis of leaflets, which appear dried and curl upward. The necrotic areas gradually widen leading to wilting of the leaves. The pathogen can also invade the xylem tissues via wounds of roots or stem and spread in the whole plant causing systemic infection. Systemic infection of xylem vessels by Cmm leads to the appearance of typical disease symptoms in the form of unilateral wilting, leaflet necrosis, vascular discoloration, appearance of canker lesions on stems and ultimately death of the plant. Bacterial infection of the fruit surface shows typical dotted lesions with white halos called “bird's-eye” and the resulting seeds from these fruits could be contaminated with Cmm. Infection at the late stages of plant development results in asymptomatic infection resulting in the production of contaminated seeds, a major source of disease outbreak of Cmm in commercial tomato production. The pathogen can survive on the plant debris in soil for up to 3 years and can infect seeds and seedlings/plants.

The control of Cmm is challenging. Unfortunately, resistant or highly tolerant tomato cultivars are still not available for commercial production and there is no effective method to control Cmm in tomatoes. Streptomycin and copper application have been shown to reduce epiphytic populations of Cmm and disease symptoms on plants. However, application of antibiotics and copper-based compounds are considered to result in the development of pathogen resistance and phytotoxic effects, and thus have raised safety and environmental concerns. The use of endolysins from bacteriophage specifically lysing Cmm has been proposed as an alternative approach to control Cmm; however, it has not yet been widely implemented.

There is, therefore, a need for a safe and effective method and composition for protecting tomatoes from Cmm.

### 2. SUMMARY

The present invention relates to a novel composition for protecting tomatoes from cmm, and methods of making and using the compositions.

Specifically, in an aspect, the present invention provides a method of protecting tomatoes from Cmm, comprising the step of: applying an effective amount of a bacterial culture comprising Bacillus pumilus to a tomato plant, wherein the tomato plant is exposed to Cmm, wherein the effective amount is sufficient for bioprotection of the tomato plant from Cmm.

In some embodiments, the bacterial culture comprises a culture medium inoculated with Bacillus pumilus.

In some embodiments, the bacterial culture is bottled before the step of applying. In some embodiments, the bacterial culture is incubated with Bacillus pumilus for 3-20 days, 5-15 days, 5-10 days, 6-8 days or 7 days before being bottled. In some embodiments, the bacterial culture is incubated with Bacillus pumilus at 25-37° C., 28-35° C., 28-32° C. or 30° C. before being bottled.

In some embodiments, the culture medium is an LB broth.

In some embodiments, the bacterial culture comprises Micrococcin P1. In some embodiments, the bacterial culture comprises Micrococcin P1 at a concentration above 100 μg/L, 150 μg/L, 200 μg/L, 300 μg/L, 500 μg/L, 600 μg/L, 1000 μg/L, or 5000 μg/L. In some embodiments, the Micrococcin P1 is produced by the Bacillus pumilus.

In some embodiments, before the step of applying the bacterial culture to the tomato plant, the bacterial culture is mixed with a cell free supernatant of a microorganism mixture comprising Lactobacillus paracasei, Lactobacillus helveticus, Lactobacillus plantarum, Lactobacillus rhamnosus, Lactococcus lactis, Bacillus amyloliquefaciens, Aspergillus oryzae, Saccharomyces cerevisiae, Candida utilis, and Rhodopseudomonas palustris. In some embodiments, before the step of applying the bacterial culture to the tomato plant, the bacterial culture is mixed with a cell free supernatant of a microorganism mixture, wherein the microorganism mixture is produced by incubating IN-M1, deposited under ATCC Accession No. PTA-12383, or IN-M2, deposited under ATCC Accession No. PTA-121556. In some embodiments, the bacterial culture is mixed with a different bacterial culture comprising Bacillus subtilus, before the step of applying the bacterial culture to the tomato plant.

In some embodiments, the tomato plant is rooted in a pot or in a field.

In some embodiments, the bacterial culture comprises Bacillus pumilus at a concentration between 10⁷ and 10⁹ CFU/mL, between 2.5×10⁷ and 10⁹ CFU/mL, between 2.5×10⁷ and 8.5×10⁸ CFU/mL, between 5×10⁷ and 8.5×10⁸ CFU/mL, between 2×10⁸ and 8.5×10⁸ CFU/mL, or 10⁸ CFU/mL. In some embodiments, the bacterial culture is applied to the tomato plant to make a final concentration of Bacillus pumilus measured in root, stem or leaf of the tomato plant to range between 10′ and 10⁹ CFU/cm³, between 2.5×10⁷ and 10⁹ CFU/cm³, between 2.5×10⁷ and 8.5×10⁸ CFU/cm³, between 5×10⁷ and 8.5×10⁸ CFU/cm³, between 2×10⁸ and 8.5×10⁸ CFU/cm³, between 3×10⁸ and 8×10⁸ CFU/cm³, or 10⁸ CFU/cm³.

In some embodiments, the bacterial culture is applied to root, leaf or stem of the tomato plant.

In some embodiments, the effective amount is sufficient to reduce Cmm concentration in a tissue of the tomato plant. In some embodiments, Cmm concentration measured 10 days after the step of applying is lower than 10⁹ CFU/g. In some embodiments, Cmm concentration measured 21 days after the step of applying is lower than 10⁹ CFU/g. The tissue of the tomato plant can be root, stem or leaf.

Another aspect of the present invention provides a method of protecting tomatoes from, comprising the step of: applying an effective amount of a bacterial culture comprising Bacillus subtilus to a tomato plant, wherein the tomato plant is exposed to Cmm, wherein the effective amount is sufficient for bioprotection of the tomato plant from Cmm.

In some embodiments, the bacterial culture comprises a culture medium inoculated with Bacillus subtilus.

In some embodiments, the bacterial culture is bottled before the step of applying. In some embodiments, the bacterial culture is incubated with Bacillus subtilus for 3-20 days, 5-15 days, 5-10 days, 6-8 days or 7 days before being bottled. In some embodiments, the bacterial culture is incubated with Bacillus subtilus at 25-37° C., 28-35° C., 28-32° C. or 30° C. before being bottled.

In some embodiments, the culture medium is an LB broth.

In some embodiments, before the step of applying the bacterial culture to the tomato plant, the bacterial culture is mixed with a cell free supernatant of a microorganism mixture comprising Lactobacillus paracasei, Lactobacillus helveticus, Lactobacillus plantarum, Lactobacillus rhamnosus, Lactococcus lactis, Bacillus amyloliquefaciens, Aspergillus oryzae, Saccharomyces cerevisiae, Candida utilis, and Rhodopseudomonas palustris. In some embodiments, before the step of applying the bacterial culture to the tomato plant, the bacterial culture is mixed with a cell free supernatant of a microorganism mixture, wherein the microorganism mixture is produced by incubating IN-M1, deposited under ATCC Accession No. PTA-12383, or IN-M2, deposited under ATCC Accession No. PTA-121556. In some embodiments, the bacterial culture is mixed with a different bacterial culture comprising Bacillus pumilus, before the step of applying the bacterial culture to the tomato plant.

In some embodiments, the tomato plant is rooted in a pot or in a field.

In some embodiments, the bacterial culture comprises Bacillus subtilus at a concentration between 10⁷ and 10⁹ CFU/mL, between 2.5×10⁷ and 10⁹ CFU/mL, between 2.5×10⁷ and 8.5×10⁸ CFU/mL, between 5×10⁷ and 8.5×10⁸ CFU/mL, between 2×10⁸ and 8.5×10⁸ CFU/mL, or 10⁸ CFU/mL. In some embodiments, the bacterial culture is applied to the tomato plant to make a final concentration of Bacillus subtilus measured in root, stem or leaf of the tomato plant to range between 10⁷ and 10⁹ CFU/cm³, between 2.5×10⁷ and 10⁹ CFU/cm³, between 2.5×10⁷ and 8.5×10⁸ CFU/cm³, between 5×10⁷ and 8.5×10⁸ CFU/cm³, between 2×10⁸ and 8.5×10⁸ CFU/cm³, between 3×10⁸ and 8×10⁸ CFU/cm³, or 10⁸ CFU/cm³.

In some embodiments, the bacterial culture is applied to root, leaf or stem of the tomato plant.

In some embodiments, the effective amount is sufficient to reduce Cmm concentration in a tissue of the tomato plant. In some embodiments, Cmm concentration measured 10 days after the step of applying is lower than 10⁹ CFU/g. In some embodiments, Cmm concentration measured 21 days after the step of applying is lower than 10⁹ CFU/g. In some embodiments, Cmm concentration measured 10 days or 21 days after the step of applying is lower than 10⁸ CFU/g. The tissue of the tomato plant can be root, stem or leaf.

Another aspect of the present invention relates to a composition for treatment of Cmm comprising: an effective amount of Micrococcin P1; and an agriculturally acceptable carrier, wherein the effective amount is sufficient for bioprotection of a tomato plant from Cmm.

In some embodiments, the agriculturally acceptable carrier is selected from the group consisting of a culture medium, a filtered fraction of a culture medium, or a filtered fraction of a microbial culture.

In some embodiments, the agriculturally acceptable carrier comprises a culture medium inoculated with Bacillus pumilus.

In some embodiments, the culture medium is bottled. In some embodiments, the culture medium is incubated with Bacillus pumilus for 3-20 days, 5-15 days, 5-10 days, 6-8 days or 7 days before being bottled. In some embodiments, the culture medium is incubated with Bacillus pumilus at 25-37° C., 28-35° C., 28-32° C. or 30° C. before being bottled.

In some embodiments, the composition further comprises Bacillus subtilus.

In some embodiments, the composition further comprises a filtered fraction of a microbial culture. In some embodiments, the composition does not comprise a filtered fraction of a microbial culture.

In some embodiments, the microbial culture comprises Lactobacillus paracasei, Lactobacillus helveticus, Lactobacillus plantarum, Lactobacillus rhamnosus, Lactococcus lactis, Bacillus amyloliquefaciens, Aspergillus oryzae, Saccharomyces cerevisiae, Candida utilis, and Rhodopseudomonas palustris. In some embodiments, the microbial culture is produced by incubating N-M1, deposited under ATCC Accession No. PTA-12383, or IN-M2, deposited under ATCC Accession No. PTA-121556.

In some embodiments, the effective amount of Micrococcin P1 is above 100 μg/L, 150 μg/L, 200 μg/L, 300 μg/L, 500 μg/L, 600 μg/L, 1000 μg/L, or 5000 μg/L.

In some embodiments, the composition comprises Bacillus pumilus at a concentration between 10⁷ and 10⁹ CFU/mL, between 2.5×10⁷ and 10⁹ CFU/mL, between 2.5×10⁷ and 8.5×10⁸ CFU/mL, between 5×10⁷ and 8.5×10⁸ CFU/mL, between 2×10⁸ and 8.5×10⁸ CFU/mL, or 10⁸ CFU/mL. In some embodiments, the composition comprises Bacillus subtilus at a concentration between 10⁷ and 10⁹ CFU/mL, between 2.5×10⁷ and 10⁹ CFU/mL, between 2.5×10⁷ and 8.5×10⁸ CFU/mL, between 5×10⁷ and 8.5×10⁸ CFU/mL, between 2×10⁸ and 8.5×10⁸ CFU/mL, or 10⁸ CFU/mL.

In some embodiments, the composition further comprises copper or a copper alloy.

In one aspect, the present invention provides a method of protecting tomatoes from Cmm, comprising the step of: applying an effective amount of the composition of the present invention to a tomato plant, wherein the tomato plant is exposed to Cmm, wherein the effective amount is sufficient for bioprotection of the tomato plant from Cmm.

### 3. BRIEF DESCRIPTION OF THE DRAWINGS

FIG. 1 provides a picture of a Cmm culture plate spotted with a drop of Bacillus subtilis (left) and a drop of Bacillus pumilus culture (right).

FIG. 2A provides HPLC chromatogram of purified extract from Bacillus pumilus culture with RT 8.140 min. FIG. 2B provides HPLC chromatogram of standard Micrococcin P1 with RT 8.115 min.

FIG. 3A provides LC-MS chromatorgram of purified Micrococcin P1, with various adducts, from Bacillus pumilus culture. FIG. 3B provides LC-MS chromatorgram of standard Micrococcin P1 with various adducts.

FIG. 4A provides ESI-MS spectrum of purified extract from Bacillus pumilus culture. FIG. 4B provides ESI-MS spectrum of standard Micrococcin P1.

FIG. 5 provides the chemical structure of Micrococcin P1.

FIG. 6 provides a picture of a Cmm culture plate spotted with drops of the partially purified extract of the Bacillus pumilus culture containing Micrococcin P1.

FIG. 7 provides antibacterial activities of Micrococcin P1 against Cmm at various concentrations.

FIG. 8 provides Agarose gel electrophoresis of PCR amplification products of CelA gene from extracted DNA samples of Cmm, B. pumilus and B. subtilis. Samples were loaded in duplicate (1 and 2).

FIG. 9 is a real-time PCR standard curve of CelA gene amplified from a leaf tissue sample.

FIG. 10 is a real-time PCR standard curve of CelA gene amplified from a stem tissue sample.

FIG. 11 is a real-time PCR standard curve of CelA gene amplified from a root tissue sample.

FIG. 12A provides CelA gene detected by a real-time PCR in a leaf tissue sample from tomatoes treated with Cmm (“Cmm”), Cmm together with Bacillus pumilus (“Bp”), Cmm together with Bacillus subtilis (“Bs”), or Cmm together with both Bacillus pumilus and Bacillus subtilis (“Mix”) in Experiment I (Table 6). FIG. 12B provides CelA gene detected by a real-time PCR in a leaf tissue sample from tomatoes treated with Cmm (“Cmm”), Cmm together with Bacillus pumilus (“Bp”), Cmm together with Bacillus subtilis (“Bs”), or Cmm together with both Bacillus pumilus and Bacillus subtilis (“Mix”) in Experiment II (Table 6).

FIG. 13A provides CelA gene detected by a real-time PCR in a stem tissue sample from tomatoes treated with Cmm (“Cmm”), Cmm together with Bacillus pumilus (“Bp”), Cmm together with Bacillus subtilis (“Bs”), or Cmm together with both Bacillus pumilus and Bacillus subtilis (“Mix”) in Experiment I (Table 6). FIG. 13B provides CelA gene detected by a real-time PCR in a stem tissue sample from tomatoes treated with Cmm (“Cmm”), Cmm together with Bacillus pumilus (“Bp”), Cmm together with Bacillus subtilis (“Bs”), or Cmm together with both Bacillus pumilus and Bacillus subtilis (“Mix”) in Experiment II (Table 6).

FIG. 14A provides CelA gene detected by a real-time PCR in a root tissue sample from tomatoes treated with Cmm (“Cmm”), Cmm together with Bacillus pumilus (“Bp”), Cmm together with Bacillus subtilis (“Bs”), or Cmm together with both Bacillus pumilus and Bacillus subtilis (“Mix”) in Experiment I (Table 6). FIG. 14B provides CelA gene detected by a real-time PCR in a root tissue sample from tomatoes treated with Cmm (“Cmm”), Cmm together with Bacillus pumilus (“Bp”), Cmm together with Bacillus subtilis (“Bs”), or Cmm together with both Bacillus pumilus and Bacillus subtilis (“Mix”) in Experiment II (Table 6).

The figures depict various embodiments of the present invention for purposes of illustration only. One skilled in the art will readily recognize from the following discussion that alternative embodiments of the structures and methods illustrated herein may be employed without departing from the principles of the invention described herein.

### 4. DETAILED DESCRIPTION

### 4.1. Definitions

Unless defined otherwise, all technical and scientific terms used herein have the meaning commonly understood by a person skilled in the art to which this invention belongs. As used herein, the following terms have the meanings ascribed to them below.

The term “microorganism” as used herein includes, but is not limited to, bacteria, viruses, fungi, algae, yeasts, protozoa, worms, spirochetes, single-celled, and multi-celled organisms that are included in classification schema as prokaryotes, eukaryotes, Archea, and Bacteria, and those that are known to those skilled in the art.

The term “antimicrobial” as used herein refers to an efficacy or activity (i.e., of an agent or extract) that reduces or eliminates the (relative) number of active microorganisms or reduces the pathological results of a microbial infection. An “antimicrobial agent,” as used herein, refers to a bioprotectant agent that prevents or reduces in-vitro and/or in-vivo infections or damages of a plant caused by a pathogenic microorganism. The antimicrobial agent includes, but is not limited to, an antibacterial agent, antiviral agent, and antifungal agent.

The term “carrier” as used herein refers to an “agriculturally acceptable carrier.” An “agriculturally acceptable carrier” is intended to refer to any material which can be used to deliver a microbial composition as described herein, agriculturally beneficial ingredient(s), biologically active ingredient(s), etc., to a plant, a plant part (e.g., a seed), or a soil, and preferably which carrier can be added (to the plant, plant part (e.g., seed), or soil) without having an adverse effect on plant growth, soil structure, soil drainage or the like.

The term “effective amount” as used herein refers to a dose or amount that produces the desired effect for which it is used. In the context of the present methods, an effective amount is an amount effective for bioprotection by its antimicrobial activity.

The term “sufficient amount” as used herein refers to an amount sufficient to produce a desired effect. Specifically, the term “effective amount sufficient for bioprotection from Cmm” as used herein refers to a dose or amount that is sufficient for bioprotection from pathological symptoms associated with Cmm infection.

The term “pathological symptom associated with Cmm” as used herein refers to various symptoms detected in tomatoes infected with Cmm. The symptoms include, but not limited to, necrosis of leaflets, wilting of leaves, blister-like spots on leaves, wilting and canker on the stem, vascular discoloration, and death of plants. The symptoms further include dotted lesions with white halos called “bird's-eye” on the fruit surface and seeds contaminated with Cmm. Cmm infection can also lead to decrease of total yields or marketable yields of tomatoes.

The term “bioprotectant(s)” as used herein refers to any composition capable of enhancing the antimicrobial activity of a plant, antinematocidal activity of a plant, a reduction in pathological symptoms or lesions resulting from actions of a plant pathogen, compared to an untreated control plant otherwise situated in a similar environment. Unless clearly stated otherwise, a bioprotectant may be comprised of a single ingredient or a combination of several different ingredients, and the enhanced antimicrobial activity may be attributed to one or more of the ingredients, either acting independently or in combination.

The term “strain” refers in general to a closed population of organisms of the same species. Accordingly, the term “strain of lactic acid bacteria” generally refers to a strain of a species of lactic acid bacteria. More particularly, the term “strain” refers to members of a microbial species, wherein such members, i.e., strains, have different genotypes and/or phenotypes. Herein, the term “genotype” encompasses both the genomic and the recombinant DNA content of a microorganism and the microorganism's proteomic and/or metabolomic profile and post-translational modifications thereof. Herein, the term “phenotype” refers to observable physical characteristics dependent upon the genetic constitution of a microorganism. As one skilled in the art would recognize, microbial strains are thus composed of individual microbial cells having a common genotype and/or phenotype. Further, individual microbial cells may have specific characteristics (e.g., a specific rep-PCR pattern) which may identify them as belonging to their particular strain. A microbial strain can comprise one or more isolates of a microorganism.

The term “tomato plant exposed to Cmm” as used herein refers to a tomato plant (1) having a tissue with at least 10³ CFU/g of Cmm, (2) used to have a tissue with at least 10³ CFU/g of Cmm, (3) grown from a seed infected with Cmm, (4) grown from a seed from a parent tomato plant, wherein the parent tomato plant had a tissue with at least 10³ CFU/g of Cmm, (5) planted in a soil with at least 10³ CFU/g of Cmm, or (6) planted in a soil, wherein a plant rooted in the soil had at least 10³ CFU/g of Cmm. The term further includes a tomato plant (1) having at least one symptom associated with Cmm infection, (2) used to have at least one symptom associated with Cmm infection, (3) grown from a seed having at least one symptom associated with Cmm infection, (4) grown from a seed from a parent tomato plant, wherein the parent tomato plant had at least one symptom associated with Cmm infection, or (5) planted in a soil, wherein a plant rooted in the soil had at least one symptom associated with Cmm infection.

The term “soil exposed to Cmm” as used herein refers to a soil (1) where a plant previously rooted therein showed a pathological symptom associated with Cmm, (2) where a plant currently rooted therein shows a pathological symptom associated with Cmm, or (3) where a tomato plant which will be planted therein without any antimicrobial treatment is expected to show a pathological symptom associated with Cmm.

### 4.2. Other Interpretational Conventions

Ranges recited herein are understood to be shorthand for all of the values within the range, inclusive of the recited endpoints. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50.

Unless otherwise indicated, reference to a compound that has one or more stereocenters intends each stereoisomer, and all combinations of stereoisomers, thereof.

### 4.3. Antimicrobial Compositions for Bioprotection of Tomatoes from Cmm

In a first aspect, compositions are presented for protecting tomatoes from Cmm. In some embodiments, the compositions comprise a bacterial culture comprising one or more Bacillus strain, such as Bacillus pumilus and Bacillus subtilus, demonstrated to be effective in inhibiting activity of Cmm. The compositions can comprise Bacillus pumilus, Bacillus subtilus, or both Bacillus pumilus and Bacillus subtilus. In some embodiments, the compositions comprise a bacterial culture of Bacillus pumilus, a bacterial culture of Bacillus subtilus, or a bacterial culture of both Bacillus pumilus and Bacillus subtilus.

In some embodiments, the compositions comprise crude extracts from the Bacillus strain. Specifically, the composition can comprise crude extracts from Bacillus pumilus or Bacillus subtilus. In some embodiments, the composition comprises crude extracts from both Bacillus pumilus and Bacillus subtilus. In some embodiments, the composition comprises a purified fraction of crude extracts from Bacillus pumilus, Bacillus subtilus, or both.

In some embodiments, the compositions comprise Micrococcin P1 as an active component. In some embodiments, Micrococcin P1 is produced from bacteria. In other embodiments, chemically synthesized Micrococcin P1 is used.

In some embodiments, the compositions further comprise an agriculturally acceptable carrier. In some embodiments, the compositions comprise a cell-free supernatant of a microbial culture as an agriculturally acceptable carrier.

### 4.3.1. Active Components

### 4.3.1.1.Bacillus Pumilus

In some embodiments, the compositions for bioprotection of tomatoes from Cmm comprise a bacterial culture comprising Bacillus pumilus. The bacterial culture comprising Bacillus pumilus can be obtained by inoculating and culturing Bacillus pumilus.

Bacillus pumilus used in various embodiments of the present invention can be a bacterial strain identified to have at least 95%, 96%, 97%, 98%, 99%, 99.5%, 99.8%, 99.9% or 100% identy to the 16S rRNA sequence of SEQ ID NO: 4. In some embodiments, Bacillus pumilus strain NES-CAP-1 (GenBank Accession No. MF079281.1) is used.

Bacillus pumilus used in various embodiments of the present invention can be a bacterial strain identified to have at least 95%, 96%, 97%, 98%, 99%, 99.5%, 99.8%, 99.9% or 100% identity to “Bacillus pumilus” by API test.

Bacillus pumilus used in various embodiments of the present invention can be a Bacillus pumilus strain identified to express Micrococcin P1. Expression of Micrococcin P1 can be tested using various methods known in the art, such as liquid chromatography(HPLC) and mass spectrometry. In some embodiments, Bacillus pumilus is selected based on its expression level of Micrococcin P1. In some embodiments, a Bacillus pumilus strain selected when it can express at least 100 μg/L, 150 μg/L, 200 μg/L, 300 μg/L, 500 μg/L, 600 μg/L, 1000 μg/L, or 5000 μg/L of Micrococcin P1 when incubated in a culture medium for 3-20 days, 5-15 days, 5-10 days, 6-8 days or 7 days.

In some embodiments, Bacillus pumilus is selected based on its capability to suppress activity or growth of Cmm on an agar plate. In some embodiments, Bacillus pumilus is selected based on the capability of its extract to suppress activity or growth of Cmm on an agar plate. In some embodiments, Bacillus pumilus is selected based on its capability to protect a tomato from Cmm in a pot. In some embodiments, Bacillus pumilus is selected based on its capability to protect a tomato from Cmm in a field.

The capability to protect a tomato from Cmm can be determined by comparing damages of tomatoes associated with Cmm with and without treatment with Bacillus pumilus. The capability to protect a tomato from Cmm can be determined by visual inspection of the tomatoes with and without treatment with Bacillus pumilus. The capability to protect a tomato from Cmm can be determined by measuring the concentration of Cmm, or the amount of a gene specific to Cmm from a tissue of a tomato plant with and without treatment with Bacillus pumilus.

In some embodiments, a Bacillus pumilus strain is selected when it can reduce the concentration of Cmm or the amount of a gene specific to Cmm in the tomato plant treated with the Bacillus pumilus. In some embodiments, a Bacillus pumilus strain is selected when it can reduce the concentration of Cmm or the amount of a gene specific to Cmm associated with Cmm by at least 10%, 20%, 30%, 40%, 50%, 60%, 70%, 80%, 90%, 95% in a pot or in field. In some embodiments, a Bacillus pumilus strain is selected when it can reduce the concentration of Cmm to below 10¹⁰ CFU/g, 10⁹ CFU/g, 10⁸ CFU/g, or 10⁷ CFU/g. The reduction of the concentration of Cmm or the amount of a gene specific to Cmm can be determined at least 5 days, 7 days, 10 days, 14 days, 21 days, 28 days, 40 days, or 50 days after treatment with a Bacillus pumilus strain. The reduction of the concentration of Cmm or the amount of a gene specific to Cmm can be determined at least 1 week, 2 weeks, 3 weeks, 4 weeks, 5 weeks, 6 weeks, 7 weeks, or 8 weeks after treatment with a Bacillus pumilus strain.

In some embodiments, Bacillus pumilus strain is selected when it can reduce damages associated with Cmm by at least 10%, 20%, 30%, 40%, 50%, 60%, 70%, 80%, 90%, 95% in a pot or field.

In some embodiments, the bacterial culture comprising Bacillus pumilus is obtained by inoculating Bacillus pumilus into a culture medium. The culture medium can be an LB broth or other culture medium available in the art.

In some embodiments, the culture medium inoculated with Bacillus pumilus can be incubated for 1 day, 2 days, 3-30 days, 3-20 days, 5-15 days, 5-10 days, 6-8 days or 7 days before being bottled. In some embodiments, the culture medium inoculated with Bacillus pumilus can be incubated at 20-37° C., 25-37° C., 28-35° C., 28-32° C. or 30° C.

In some embodiments, the Bacillus strain is selected for its capability to generate a zone of inhibition with a diameter larger than 2 mm when 1 μL, 2 μL, 3 μL, 4 μL, 5 μL, 6 μL, 7 μL, 8 μL, 9 μL 10 μL, 10-20 μL, 20-30 μL, 30-40 μL, 40-50 μL, 50-100 μL, 100-500 μL, 500-1000 μL of the bacterial culture is applied. In some embodiments, the zone of inhibition has a diameter larger than 3 mm, larger than 4 mm, larger than 5 mm, larger than 6 mm, larger than 7 mm, larger than 8 mm, larger than 9 mm, larger than 1 cm, or larger than 1.5 cm, when measured after incubation. The diameter can be measured 1 day, 2 days, 3 days, 3-7 days, or 5-10 days after application of the bacterial culture.

In some embodiments, the Bacillus strain is selected for its capability to generate a zone of inhibition with a diameter larger than 2 mm when 1 μL, 2 μL, 3 μL, 4 μL, 5 μL, 6 μL, 7 μL, 8 μL, 9 μL 10 μL, 10-20 μL, 20-30 μL, 30-40 μL, 40-50 μL, or 50-100 μL of the crude extract from the bacterial culture is applied. In some embodiments, the zone of inhibition has a diameter larger than 3 mm, larger than 4 mm, larger than 5 mm, larger than 6 mm, larger than 7 mm, larger than 8 mm, larger than 9 mm, larger than 1 cm, or larger than 1.5 cm, when measured after incubation. The diameter can be measured 1 day, 2 days, 3 days, 3-7 days, or 5-10 days of incubation after application of the crude extract.

In some embodiments, the composition comprises a strain of Bacillus pumilus (“Bacillus pumilus strain ITI-1” or “ITI-1”) deposited with the Americal Type Culture Collection (ATCC), with the ATCC® Patent Designation No. of PTA-125304, under the Budapest Treaty on Sep. 26, 2018, under ATCC Account No. 200139.

### 4.3.1.2.Bacillus Subtilus

In some embodiments, the compositions for bioprotection of tomatoes from Cmm comprise a bacterial culture comprising Bacillus subtilus. The bacterial culture comprising Bacillus subtilus can be obtained by inoculating and culturing Bacillus subtilus.

Bacillus subtilus used in various embodiments of the present invention can be a bacterial strain identified to have at least 95%, 96%, 97%, 98%, 99%, 99.5%, 99.8%, 99.9% or 100% identy to the 16S rRNA sequence of SEQ ID NOS: 5 or 6. In some embodiments, Bacillus subtilis strain BSFLG01 (GenBank Accession No. MF196314.1) is used. In some embodiments, Bacillus subtilis strain SSL2 (GenBank Accession No. MH192382.1) is used.

Bacillus subtilus used in various embodiments of the present invention can be a bacterial strain identified to have at least 95%, 96%, 97%, 98%, 99%, 99.5%, 99.8%, 99.9% or 100% identity to “Bacillus subtilus” by API test.

In some embodiments, Bacillus subtilus is selected based on its capability to suppress activity or growth of Cmm on an agar plate. In some embodiments, Bacillus subtilus is selected based on the capability of its extract to suppress activity or growth of Cmm on an agar plate. In some embodiments, Bacillus subtilus is selected based on its capability to protect a tomato from Cmm in a pot. In some embodiments, Bacillus subtilus is selected based on its capability to protect a tomato from Cmm in a field.

The capability to protect a tomato from Cmm can be determined by comparing damages of tomatoes associated with Cmm with and without treatment with Bacillus subtilus. The capability to protect a tomato from Cmm can be determined by visual inspection of the tomatoes with and without treatment with Bacillus subtilus. The capability to protect a tomato from Cmm can be determined by measuring the concentration of Cmm, or the amount of a gene specific to Cmm from a tissue of a tomato plant with and without treatment with Bacillus subtilus.

In some embodiments, a Bacillus subtilus strain is selected when it can reduce the concentration of Cmm or the amount of a gene specific to Cmm in the tomato plant treated with the Bacillus subtilus. In some embodiments, a Bacillus subtilus strain is selected when it can reduce the concentration of Cmm or the amount of a gene specific to Cmm associated with Cmm by at least 10%, 20%, 30%, 40%, 50%, 60%, 70%, 80%, 90%, 95% in a pot or field. In some embodiments, a Bacillus subtilus strain is selected when it can reduce the concentration of Cmm to below 10¹⁰ CFU/g, 10⁹ CFU/g, 10⁸ CFU/g, or 10⁷ CFU/g. The reduction of the concentration of Cmm or the amount of a gene specific to Cmm can be determined at least 5 days, 7 days, 10 days, 14 days, 21 days, 28 days, 40 days, or 50 days after treatment with a Bacillus subtilus strain. The reduction of the concentration of Cmm or the amount of a gene specific to Cmm can be determined at least 1 week, 2 weeks, 3 weeks, 4 weeks, 5 weeks, 6 weeks, 7 weeks, or 8 weeks after treatment with a Bacillus subtilus strain.

In some embodiments, Bacillus subtilus strain is selected when it can reduce damages associated with Cmm by at least 10%, 20%, 30%, 40%, 50%, 60%, 70%, 80%, 90%, 95% in a pot or field.

In some embodiments, the bacterial culture comprising Bacillus subtilus is obtained by inoculating Bacillus subtilus into a culture medium. The culture medium can be an LB broth or other culture medium available in the art.

In some embodiments, the culture medium inoculated with Bacillus subtilus can be incubated for 1 day, 2 days, 3-30 days, 3-20 days, 5-15 days, 5-10 days, 6-8 days or 7 days before being bottled. In some embodiments, the culture medium inoculated with Bacillus subtilus can be incubated at 20-37° C., 25-37° C., 28-35° C., 28-32° C. or 30° C.

In some embodiments, the Bacillus strain is selected for its capability to generate a zone of inhibition with a diameter larger than 2 mm when 1 μL, 2 μL, 3 μL, 4 μL, 5 μL, 6 μL, 7 μL, 8 μL, 9 μL 10 μL, 10-20 μL, 20-30 μL, 30-40 μL, 40-50 μL, 50-100 μL, 100-500 μL, 500-1000 μL of the bacterial culture is applied. In some embodiments, the zone of inhibition has a diameter larger than 3 mm, larger than 4 mm, larger than 5 mm, larger than 6 mm, larger than 7 mm, larger than 8 mm, larger than 9 mm, larger than 1 cm, or larger than 1.5 cm, when measured after incubation. The diameter can be measured 1 day, 2 days, 3 days, 3-7 days, or 5-10 days after application of the bacterial culture.

In some embodiments, the Bacillus strain is selected for its capability to generate a zone of inhibition with a diameter larger than 2 mm when 1 μL, 2 μL, 3 μL, 4 μL, 5 μL, 6 μL, 7 μL, 8 μL, 9 μL 10 μL, 10-20 μL, 20-30 μL, 30-40 μL, 40-50 μL, or 50-100 μL of the crude extract from the bacterial culture is applied. In some embodiments, the zone of inhibition has a diameter larger than 3 mm, larger than 4 mm, larger than 5 mm, larger than 6 mm, larger than 7 mm, larger than 8 mm, larger than 9 mm, larger than 1 cm, or larger than 1.5 cm, when measured after incubation. The diameter can be measured 1 day, 2 days, 3 days, 3-7 days, or 5-10 days of incubation after application of the crude extract.

In some embodiments, the composition comprises a strain of Bacillus subtilus (“Bacillus subtilus strain ITI-2” or “ITI-2”) deposited with the the ATCC® Patent Designation No. of PTA-125303 under the Budapest Treaty on Sep. 26, 2018, under ATCC Account No. 200139. In some embodiments, the composition comprises a strain of Bacillus subtilus (“Bacillus subtilus strain ITI-3” or “ITI-3”), deposited with the ATCC® Patent Designation No. of PTA-125302 under the Budapest Treaty on Sep. 26, 2018, under ATCC Account No. 200139.

### 4.3.1.3.Micrococcin P1

In some embodiments, the composition of the present invention comprises Micrococcin P1. In some embodiments, Micrococcin P1 is produced by a Bacillus strain. The Bacillus strain can be selected based on its expression of Micrococcin P1. The Bacillus strain can be Bacillus pumilus.

In some embodiments, the composition comprises Micrococcin P1 produced by a genetically engineered bacterium. In some embodiments, the bacterium is genetically engineered to produce Micrococcin P1 by delivering one or more genes involved in the biosynthesis of Micrococcin P1. In some embodiments, the bacterium is genetically engineered by using the method described in Philip R. Bennallack et al., Reconstitution and Minimization of a Micrococcin Biosynthetic Pathway in Bacillus subtilis, Journal of Bacteriology (2016), incorporated by reference in its entirety herein.

In some cases, the composition comprises Micrococcin P1 by comprising bacteria capable of expressing Micrococcin P1 naturally or by a genetic modification. In other cases, the composition comprises Micrococcin P1 by including crude extracts of the bacteria capable of expression of Micrococcin P1 naturally or by genetic engineering. The crude extracts can be generated by obtaining a fraction of the bacterial culture including Micrococcin P1.

Micrococcin P1 can be present at a concentration sufficient to induce a zone of inhibition when the composition is applied to an agar plate culture of Cmm. Micrococcin P1 can be present at a concentration sufficient to protect a tomato from Cmm when the composition is applied to a pot. Micrococcin P1 can be present at a concentration sufficient to protect a tomato from Cmm when the composition is applied to a field. The concentration of Micrococcin P1 effective for the bioprotection from Cmm can be determined by testing dose-dependent responses. In some embodiments, Micrococcin P1 is present at a concentration greater than 1 μg/L, 10 μg/L, 100 μg/L, 500 μg/L, 1 mg/L, 5 mg/L, 10 mg/L, 100 mg/L, or 500 mg/L. In some embodiments, Micrococcin P1 is present at a concentration greater than 1 nM, 10 nM, 100 nM, 200 nM, 500 nM, 1 μM or 10 μM. In typical embodiments, Micrococcin P1 is present at a concentration greater than 100 μg/L or 150 μg/L.

In some embodiments, Micrococcin P1 is applied at a concentration greater than 1 μg/L, 10 μg/L, 100 μg/L, 500 μg/L, 1 mg/L, 5 mg/L, 10 mg/L, 100 mg/L, or 500 mg/L. In typical embodiments, Micrococcin P1 is applied at a concentration greater than 100 μg/L or 150 μg/L.

In some embodiments, Micrococcin P1 is applied at an amount greater than 1 μg/Acre, 10 μg/Acre, 100 μg/Acre, 500 μg/Acre, 1 mg/Acre, 5 mg/Acre, 10 mg/Acre, 100 mg/Acre, 500 mg/Acre, or 1 g/Acre.

In some embodiments, the composition can include Micrococcin P1, which is chemically synthesized. In some embodiments, the composition can include Micrococcin P1, which is biologically produced, but purified.

### 4.3.2. Agriculturally Acceptable Carrier

In some embodiments, the compositions further comprise an agriculturally acceptable carrier. The agriculturally acceptable carrier can be added to enhance antimicrobial activity of the compositions. In some embodiments, the agriculturally acceptable carrier is added to enhance stability of the antimicrobial agent (e.g., Micrococcin P1) during storage or after application of the composition to a field. In some embodiments, the agriculturally acceptable carrier is added to provide an effective concentration of active components before being applied to a soil or to a plant.

### 4.3.2.1.Culture Medium

In some embodiments, the composition for treating Cmm infection comprise culture medium as an agriculturally acceptable carrier. Culture medium is a mixture which supports the growth of microbial cells, such as Bacillus pumilus, Bacillus subtilis, or other microbes disclosed herein. Culture medium can contain ingredients such as peptone, soy peptone, molasses, potato starch, yeast extract powder, or combinations thereof.

### 4.3.2.2. Filtered Fraction of Microbial Culture

In some embodiments, the compositions of treating Cmm further comprise a cell-free supernatant of a microbial culture inoculated with one or more isolated microorganisms, wherein the microorganism comprises Aspergillus spp., Bacillus spp., Rhodopseudomonas spp., Candida spp., Lactobacillus spp., Saccharomyces spp., or Lactococcus spp.; or combinations thereof.

In some embodiments, the compositions of treating Cmm further comprise a cell-free supernatant of a microbial culture inoculated with one or more isolated microorganisms, wherein the microorganism comprises Aspergillus spp., Bacillus spp., Rhodopseudomonas spp., Candida spp., Lactobacillus spp., Lactococcus spp., Pseudomonas spp., Saccharomyces spp., or Streptococcus spp.; or combinations thereof.

In some embodiments, the compositions of treating Cmm comprise a cell-free supernatant of a microbial culture inoculated with one or more isolated microorganisms, wherein the microorganism comprises Aspergillus spp., for example, Apergillus oryzae, IN-A01, deposited Sep. 4, 2014 with ATCC, PTA-121551; Bacillus spp., for example, Bacillus amyloliquefaciens, IN-BS1, deposited Jan. 11, 2012 with ATCC, PTA-12385; Rhodopseudomonas spp., for example, Rhodopseudomonas palustris, IN-RP1, deposited Jan. 11, 2012 with ATCC, PTA-12387; Rhodopseudomonas palustris, IN-RP2, deposited Sep. 4, 2014 with ATCC, PTA-121533; Candida spp., for example, Candida utilis, IN-CU1, deposited Sep. 4, 2014 with ATCC, PTA-12550; Lactobacillus spp., for example, Lactobacillus helveticus, IN-LH1, deposited Jan. 11, 2012, with ATCC, PTA 12386; Lactobacillus rhamnosus, IN-LR1, deposited Sep. 4, 2014 with ATCC, PTA 121554; Lactobacillus paracasei, IN-LC1, deposited Sep. 4, 2014 with ATCC, PTA-121549; Lactobacillus plantarum, IN-LP1, deposited Sep. 4, 2014 with ATCC, PTA 121555; Lactococcus spp., for example, Lactococcus lactis, IN-LL1, deposited Sep. 4, 2014 with ATCC, PTA-121552; Pseudomonas spp., for example, Pseudomonas aeuroginosa or Pseudomonas fluorescens; Saccharomyces spp., for example, Saccharomyces cerevisiae, IN-SC1, deposited on Jan. 11, 2012 with ATCC, PTA-12384; or Streptococcus spp., for example, Streptococcus lactis; or combinations thereof, or a microbial consortia comprising one or more of the above, for example, IN-M1, deposited Jan. 11, 2012 with ATCC, PTA-12383 and/or IN-M2, deposited Sep. 4, 2014 with ATCC, PTA-121556. IN-BS1, ATCC Deposit No. PTA-12385, was previously identified to be Bacillus subtilis in US Publication Nos. 20160100587 and 20160102251, and U.S. Pat. No. 9,175,258 based on 16S rRNA sequence and API testing, but later identified to be Bacillus amyoliquefaciens by full genome sequencing. IN-LC1, ATCC Deposit No. PTA-121549, was previously identified to be Lactobacillus casei in US Publication Nos. 20160100587 and 20160102251, and U.S. Pat. No. 9,175,258 based on 16S rRNA sequence and API testing, but later identified to be Lactobacillus paracasei by full genome sequencing.

In some embodiments, the cell-free supernatant is filter-sterilized or sterilized by methods known to those of skill in the art. The cell-free supernatant can be made by methods described in US Publication Nos. 20160100587 and 20160102251, and U.S. Pat. No. 9,175,258, which are incorporated by reference in their entireties herein.

For example, microorganisms grown for producing cell-free supernatant compositions of the present disclosure can be grown in fermentation, nutritive or culture broth in large, industrial scale quantities. For example, and not to be limiting, a method for growing microorganisms in 1000 L batches comprises media comprising 50 L of non-sulfur agricultural molasses, 3.75 L wheat bran, 3.75 L kelp, 3.75 L bentonite clay, 1.25 L fish emulsion (a commercially available organic soil amendment, from Nutrivert, Dunham, Quebec non-pasteurized), 1.25 L soy flour, 675 mg commercially available sea salt, 50 L selected strains of microorganisms, up to 1000 L non-chlorinated warm water. A method for growing the microorganisms can further comprise dissolving molasses in some of the warm water, adding the other ingredients to the fill tank, keeping the temperature at 30° C., and, after the pH drops to about 3.7 within 5 days, stirring lightly once per day and monitoring pH. The culture can incubate for 6 weeks or a predetermined time, the culture is then standardized (diluted or concentrated) to a concentration of 1×10⁵-1×10⁷, or 1×10⁶ cells/mL, after which the microorganisms are removed to result in a cell-free supernatant composition, a composition of the present disclosure.

A microbial culture, which is the source of a cell-free supernatant composition of the present disclosure can be inoculated with and comprise a combination of microorganisms from several genera and/or species. These microorganisms grow and live in a cooperative fashion, in that some genera or species may provide by-products or synthesized compounds that are beneficial to other microorganisms in the combination. For example, the microbial culture, which is the source of a cell-free supernatant composition of the present disclosure can be inoculated with and comprise both aerobic microorganisms, which need oxygen for metabolic activities, and anaerobic microorganisms, which use other sources of energy such as sunlight or the presence of specific substrates. This enables the microorganisms to colonize substrates in different regions of an environment. A microbial culture, which is the source of a cell-free supernatant composition of the present disclosure can be inoculated with and comprise facultative microorganisms, for example, strains of Lactobacillus, which modulate metabolic activities according to oxygen and/or nutrient concentrations in the environment.

Though not wishing to be bound by any particular theory, it is currently believed that microbial cultures, which are the sources of cell-free supernatant compositions disclosed in the present disclosure may, during fermentation (culture) produce metabolites that are reactive in a cooperative manner. For example, a substrate or enzyme excreted by one or more microorganisms can be acted on by excreted products from other microorganisms in the culture to form metabolites, which can be referred to as tertiary metabolites. These excreted products and those products formed from the interactions of excreted products may work in concert in a beneficial manner to enhance or induce bioprotective properties in plants.

All species of living organisms include individuals that vary genetically and biochemically from each other but are still within what is called the spectrum of normal variations within the species. These individual natural variations can be the result of nondisruptive substitution or deletions in the gene sequence, variation in gene expression or RNA processing and/or variations in peptide synthesis and/or variation of cellular processing of intra cellular, membrane or secreted molecules. A microbial culture, which is the source of a cell-free supernatant composition of the present disclosure can be inoculated with microorganisms that are within or without the normal variations of a species. Identification of such microorganisms may be detected by genetic, molecular biological methods known to those skilled in the art, and/or by methods of biochemical testing.

For example, a microbial culture, which is the source of a cell-free supernatant composition of the present disclosure can be inoculated with and comprise microorganisms that were selected by isolating individual colonies of a particular microorganism. The colony members were characterized, for example, by testing enzyme levels present in the isolated microorganism and the activity with particular substrates in a panel of substrates, to establish an enzyme profile for the isolated microorganism.

Examples of these microorganisms that can be grown in cultures from which cell-free supernatants are derived include, but are not limited to, Aspergillus spp., Bacillus spp., Rhodopseudomonas spp., Candida spp., Lactobacillus spp., Lactococcus spp., Pseudomonas spp., Saccharomyces spp., or Streptococcus spp.; combinations thereof, or microbial consortia comprising one or more of these microorganisms, including IN-M1, deposited Jan. 11, 2012 with ATCC, PTA-12383, and/or IN-M2, deposited Sep. 4, 2014 with ATCC, PTA-121556.

Compositions of the present disclosure can comprise differing amounts and combinations of these and other isolated microorganisms depending on the methods being performed. A microbial culture is formed by inoculating a microbial nutrient solution, commonly referred to as a broth, with one or more microorganisms disclosed herein. A microbial culture is formed by the growth and metabolic activities of the inoculated microorganisms. Thus, in various aspects, the microbial culture is inoculated with and comprises at least two of Aspergillus spp., Bacillus spp., Rhodopseudomonas spp., Candida spp., Lactobacillus spp., Pseudomonas spp., Saccharomyces spp., or Streptococcus spp. In an aspect, the microbial culture is inoculated with and comprises Aspergillus oryzae, Bacillus amyloliquefaciens, Lactobacillus helveticus, Lactobacillus paracasei, Rhodopseudomonas palustris, and Saccharomyces cervisiase. In an aspect, the microbial culture is inoculated with and comprises a mixed culture, IN-M1 (Accession No. PTA-12383). In an aspect, the microbial culture is inoculated with and comprises Aspergillus oryzae, Bacillus amyloliquefaciens, Candida utilis, Lactobacillus paracasei, Lactobacillus helveticus, Lactobacillus plantarum, Lactobacillus rhamnosus, Lactococcus lactis, Rhodopseudomonas palustris, and Saccharomyces cervisiase.

In an aspect, a microbial culture is inoculated with and comprises a mixed culture, the consortia IN-Ml, deposited with the ATCC Patent Depository under the Budapest Treaty, on Jan. 11, 2012, under Account No. 200139, and given Accession No. PTA-12383. IN-M1 consortia comprises Rhodopseudomonas palustris, IN-RP1, ATCC Deposit No. PTA-12387; Aspergillus oryzae, Saccharomyces cerevisiae, IN-SC1, ATCC Deposit No. PTA-12384, Bacillus amyoliquefaciens, IN-BS1, ATCC Deposit No. PTA-12385; Lactobacillus helveticus, IN-LH1, ATCC Deposit No. PTA-12386; and Lactobacillus paracasei. In an aspect, the microbial culture is inoculated with and comprises a mixed culture, IN-Ml, in combination with one or more disclosed microbial organisms. After growth, the microbial culture is either diluted or concentrated to be 1×10⁵-1×10⁷, or 1×10⁶ cells/mL and a cell-free supernatant composition is derived from this IN-Ml fermentation culture by removing the microorganisms that were present in the microbial fermentation culture.

In an aspect, a microbial fermentation culture is inoculated with a mixed culture, IN-M2, deposited with the ATCC Patent Depository under the Budapest Treaty, on Sep. 4, 2014, with the designation IN-M2, under Account No. 200139, with the ATCC Patent Deposit Designation No. PTA-121556. The microbial consortia, IN-M2 comprises Lactobacillus paracasei, IN-LC1, ATCC Deposit No. PTA-121549; Lactobacillus helveticus, IN-LH1, ATCC Deposit No. PTA-12386; Lactococcus lactis, IN-UL ATCC Deposit No. PTA-121552; Lactobacillus rhamnosus, IN-LR1 ATCC Deposit No. PTA-121554; Lactobacillus planterum, IN-LP1, ATCC Deposit No. PTA-121555; Rhodopseudomonas palustris IN-RPL ATCC Deposit No. PTA-12387; Rhodopseudomonas palustris, IN-RP2, ATCC Deposit No. PTA-121553; Saccharomyces cerevisiae, IN-SC1, ATCC Deposit No. PTA-12384; Candida utilis, IN-CUl, ATCC Deposit No. PTA-121550; Aspergillus oryzae, IN-AOl, ATCC Deposit No. PTA-121551; and Bacillus amyoliquefaciens, IN-BS1, ATCC Deposit No. PTA-12385. In an aspect, the microbial fermentation culture is inoculated with and comprises a mixed culture, IN-M2, in combination with one or more disclosed microbial organisms. After growth, the microbial culture is either diluted or concentrated to be 1×10⁵-1×10⁷, or 1×10⁶ cells/mL and a cell-free supernatant composition is derived from this IN-M2 culture by removing the microorganisms that were present in the microbial culture.

### 4.3.2.2.1. Selection Criteria

Compositions of microorganisms for providing a cell-free supernatant can be selected based on one or more criteria provided herein. Specifically, antimicrobial activity of active components can be combined with a cell-free supernatant of various microorganisms and then tested against Cmm on a culture plate, in a culture media, or in the field. Microorganisms are selected when their supernatant fractions provide synergistic, additive, or any other positive effect on antimicrobial activity of the active components, such as Bacillus pumilus, Bacillus pumilus, Micrococcin P1, or a combination thereof.

### 4.3.3. Other Optional Components

In some embodiments, an antimicrobial composition of the present disclosure may further comprise one or more additional or optional components, including but not limited to, herbicides, insecticides, fungicides, nutrient compounds, peptides, proteins, delivery components, or combination thereof.

In some embodiments, the antimicrobial composition further comprises a nutrient component. The nutrient component can be powders, granules, or pellets, or a liquid, including solutions or suspensions, which contains nutrients in the solution or in the mixture.

In some embodiments, the antimicrobial composition further comprises copper or its alloy, including but not limited to, brasses, bronzes, cupronickel, and copper-nickel-zinc.

### 4.4. Methods of Protecting Tomatoes from Cmm

In an aspect, provided herein are methods for protecting tomatoes from Cmm, by applying an effective amount of the antimicrobial composition of the present invention to a tomato plant exposed to Cmm. The effective amount is sufficient for bioprotection of the tomato plant from Cmm.

### 4.4.1. Methods of Application

The antimicrobial composition can be applied at a particular time, or one or more times, depending on Cmm population in a tomato plant or soil planted with a tomato plant, environmental conditions and tomato susceptibility. The compositions can be applied to root, leaf or stem of the tomato plant.

In some embodiments, the compositions are applied to a soil (1) where a plant rooted therein showed a pathological symptom associated with Cmm, (2) where a plant currently rooted therein shows a pathological symptom associated with Cmm, or (3) where a tomato plant which will be planted therein is expected to show a pathological symptom associated with Cmm. In some embodiments, the compositions are applied to the seeds that will be planted to such a soil. In some embodiments, the compositions are applied to the seeds from a parent tomato plant that has been planted to such a soil. In some embodiments, the compositions are applied to the plant that is rooted in such a soil. In some embodiments, the compositions are applied to a plant that shows a pathological symptom associated with Cmm.

The compositions can be applied subsequent to or prior to infection by Cmm. In some embodiments, the composition is applied at least 1 week, 2 weeks, 3 weeks, 1 months, 2 months, 3 months, 4 months, 5 months, or 6 months before planting a seed. In some embodiments, the composition is applied at least 1 week, 2 weeks, 3 weeks, 1 months, 2 months, or 3 months after planting a seed. In some embodiments, the composition is applied 1 week, 2 weeks, 3 weeks, 4 weeks, 5 weeks, or 5-10 weeks before harvesting a tomato.

Suitable application methods include, but are not limited to, high or low pressure spraying, drenching, coating, immersion, and soil injection. In various aspects, disclosed compositions can be applied to soil or other plant growth media and/or can be applied to seeds prior to or during planting.

When treating seeds, disclosed compositions can be applied by a variety of techniques including, but not limited to, high or low pressure spraying, coating, immersion, and injection. Once treated, seeds can be planted in natural or artificial soil and cultivated using conventional procedures to produce plants. After plants have propagated from seeds treated in accordance with the present disclosure, the plants may be treated with one or more applications of disclosed compositions.

Disclosed compositions can be applied to all or part of the plant. For example, a disclosed composition can be applied to the stems, roots, leaves, and/or propagules (e.g., cuttings). The plant may be treated at one or more developmental stages. In one embodiment, a disclosed composition is applied to roots.

In some embodiments, the compositions can be applied to a delivery vehicle, wherein the delivery vehicle serves as a means of transporting the bioprotective properties from the delivery vehicle to the soil, plant, seed, field, etc. For example, disclosed compositions can be applied to a delivery vehicle (e.g., a particle, a polymer, or a substrate) to be used in filtration systems for the treatment of irrigation water. This technique may be useful in a variety of plant environments such as fields, greenhouse facilities, vertical farms, urban greening systems, and hydroponic systems. In some embodiments, disclosed compositions can be applied to a polymer as a wetting agent and/or gel that releases water as needed. In some embodiments, disclosed compositions can be applied to a delivery system for actives that effect solubility to concentrate actives for seed coatings. As used herein, “actives,” refers to a molecule, or combination of molecules, having desired bioprotective properties that are produced during fermentation.

### 4.4.2. Amounts of Application

The antimicrobial compositions of the present invention is applied in an effective amount for bioprotection of a tomato from Cmm. In some embodiments, the amount is sufficient to prevent Cmm infection. In some embodiments, the amount is sufficient to treat or reduce one or more symptoms associated with Cmm.

In some embodiments, the amount is sufficient to reduce Cmm concentration in a tissue of a tomato plant treated with the composition. In some embodiments, Cmm concentration measured in a tissue of a tomato plant 10 days after the step of applying is lower than 10⁹ CFU/g. In some embodiments, Cmm concentration measured in a tissue of a tomato plant 21 days after the step of applying is lower than 10⁹ CFU/g. In some embodiments, Cmm concentration measured in a tissue of a tomato plant 3, 5, 7, 14, 21, 28, 35, or 42 days after the step of applying is lower than 10⁹ CFU/g. In some embodiments, Cmm concentration measured in a tissue of a tomato plant 3, 5, 7, 14, 21, 28, 35, or 42 days after the step of applying is lower than 10⁸ CFU/g. In some embodiments, Cmm concentration measured in a tissue of a tomato plant 3, 5, 7, 14, 21, 28, 35, or 42 days after the step of applying is lower than 10⁷ CFU/g. In some embodiments, Cmm concentration measured in a tissue of a tomato plant 3, 5, 7, 14, 21, 28, 35, or 42 days after the step of applying is lower than 10⁶ CFU/g.

The specific amounts vary depending on the types and condition of soils, the types and conditions of tomatoes, potency and activity of Cmm, etc. The specific amounts can also vary depending on the environment, for example, whether it is in a pot or in a field. In some embodiments, the composition of the present invention is mixed with or diluted in an agriculturally acceptable carrier before used.

The specific amounts can be determined by using methods known in the art, for example, by testing dose dependent response. In some embodiments, the specific amount is determined by testing dose dependent response on a culture plate with Cmm, for example, by measuring a zone of inhibition. In some embodiments, the specific amount is determined by testing dose dependent response in a pot or in a field. In some embodiments, the specific amount is determined based on the measurement of Cmm concentration or amount of a gene specific Cmm in a tissue of a tomato plant treated with the composition. In some embodiments, the specific amount is determined based on the concentration of Bacillus subtilus, Bacillus pumilus or both.

In some embodiments, the bacterial culture applied to a tomato plant comprises Bacillus pumilus at a concentration between 10⁷ and 10⁹ CFU/mL, between 2.5×10⁷ and 10⁹ CFU/mL, between 2.5×10⁷ and 8.5×10⁸ CFU/mL, between 5×10⁷ and 8.5×10⁸ CFU/mL, between 2×10⁸ and 8.5×10⁸ CFU/mL, or 10⁸ CFU/mL. In some embodiments, the bacterial culture applied to a tomato plant comprises Bacillus subtilus at a concentration between 10⁷ and 10⁹ CFU/mL, between 2.5×10⁷ and 10⁹ CFU/mL, between 2.5×10⁷ and 8.5×10⁸ CFU/mL, between 5×10⁷ and 8.5×10⁸ CFU/mL, between 2×10⁸ and 8.5×10⁸ CFU/mL, or 10⁸ CFU/mL.

In some embodiments, the composition is applied to the tomato plant to make a final concentration of Bacillus pumilus measured in root, stem or leaf of the tomato plant to range between 10⁷ and 10⁹ CFU/cm³, between 2.5×10⁷ and 10⁹ CFU/cm³, between 2.5×10⁷ and 8.5×10⁸ CFU/cm³, between 5×10⁷ and 8.5×10⁸ CFU/cm³, between 2×10⁸ and 8.5×10⁸ CFU/cm³, between 3×10⁸ and 8×10⁸ CFU/cm³, or 10⁸ CFU/cm³. In some embodiments, the composition is applied to the tomato plant to make a final concentration of Bacillus subtilus measured in root, stem or leaf of the tomato plant to range between 10⁷ and 10⁹ CFU/cm³, between 2.5×10⁷ and 10⁹ CFU/cm³, between 2.5×10⁷ and 8.5×10⁸ CFU/cm³, between 5×10⁷ and 8.5×10⁸ CFU/cm³, between 2×10⁸ and 8.5×10⁸ CFU/cm³, between 3×10⁸ and 8×10⁸ CFU/cm³, or 10⁸ CFU/cm³. In some embodiments, the composition is applied to the tomato plant to make a final concentration of Bacillus pumilus and Bacillus subtilus measured in root, stem or leaf of the tomato plant to range between 10⁷ and 10⁹ CFU/cm³, between 2.5×10⁷ and 10⁹ CFU/cm³, between 2.5×10⁷ and 8.5×10⁸ CFU/cm³, between 5×10⁷ and 8.5×10⁸ CFU/cm³, between 2×10⁸ and 8.5×10⁸ CFU/cm³, between 3×10⁸ and 8×10⁸ CFU/cm³, or 10⁸ CFU/cm³.

The composition can be applied in an amount that ranges between 0.2 and 3 gal/A, between 0.5 and 2.5 gal/A, between 0.75 and 2 gal/A, 0.5 gal/A, 1 gal/A, 1.25 gal/A, 1.5 gal/A, or 2 gal/A.

### 4.5. Examples

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric. Standard abbreviations can be used, e.g., bp, base pair(s); kb, kilobase(s); pl, picoliter(s); s or sec, second(s); min, minute(s); h or hr, hour(s); aa, amino acid(s); nt, nucleotide(s); and the like.

The practice of the present invention will employ, unless otherwise indicated, conventional methods of protein chemistry, biochemistry, recombinant DNA techniques and pharmacology, within the skill of the art.

### 4.5.1. Example 1: Isolation and Purification of Rhizobacteria

Rhizosphere soil and root samples were collected from various plant rhizospheres from Emile A. Lods Agronomy Research Centre (45° 26″05.5′N, 73° 55″57.2′W) and Morgan Arboretum (45° 26′ 06.5″ N, 73° 57″11.9′W) of the Macdonald Campus of McGill University. Rhizobacteria were isolated by dilution plate technique using phosphate buffered saline (PBS) solution. The rhizobacteria were serially diluted on LBA (Luria-Bertani Agar; composition (g/L): Tryptone—10 g, Yeast Extract—5 g, NaCl—5 g, Agar—15 g) and King's B Agar (composition (g/L): Peptone—20 g, glycerol—10 mL, K₂HPO₄—1.5 g, MgSO₄.7H₂O—1.5 g, Agar—15 g) plates and incubated at 30° C. for at least 3 days. The plates were frequently observed for appearance of bacterial colonies during incubation. Colonies showing differences in size, color and morphology were picked and streaked onto respective media plates followed by incubation as described earlier. Single colonies were again streaked on respective media plates until pure cultures were obtained. Morphologically distinct colonies were selected and grown in LB broth (shaken at 150 rpm on a rotary shaker at 30° C.) and stored in 25% glycerol (v/v) at −80° C.

### 4.5.2. Example 2: Screening of Antagonistic Rhizobacteria

Selected rhizobacterial isolates were cultured on LB agar (“LBA”) plates and single colonies were selected for screening studies against Cmm. Single colonies of isolates were further grown in LB broth for at least 24 h at 30° C. and shaken at 150 rpm.

Cmm was streaked on NBYA (Nutrient Broth Yeast Extract Agar) plates consisting of nutrient broth (8.0 g L⁻¹), yeast extract (2.0 g L⁻¹), K₂HPO₄ (2.0 g L⁻¹), KH₂PO₄ (0.5 g L⁻¹), glucose (5.0 g L⁻¹), MgSO₄.7H₂O (0.25 g L⁻¹) and agar (15 g L⁻¹). The plates were incubated for 72 h at 28° C. and a single colony was further subcultured in a tube containing Nutrient Broth (Difco, Detroit, Mich., USA) and further incubated for 48 h at 28° C. while being shaken at 150 rpm on an orbital shaker (Model 5430 Table Top Orbital Shaker; Forma Scientific Inc., Mariolta, Ohio, USA). A 100 μL bacterial suspension of Cmm was evenly spread on NBYA using a sterile cell spreader and allowed to air dry. The antibacterial activity of selected rhizobacterial isolates (grown overnight in LB broth under conditions described above) were tested using spot on lawn assay. A 10 μL of each test isolate was spotted on the lawn of Cmm. The plates were incubated at 28° C. for 72 h. Antibacterial activity was revealed by a zone of inhibition surrounding rhizobacterial isolates.

### 4.5.3. Example 3: Identification of the Microbes

### 4.5.3.1.Example 3-1: Identification of the Microbes Based on 16S Rrna Gene Sequences

Colonies having antagonistic activity against Cmm by creating a zone of inhibition as provided in Example 2 were selected and LB broth was inoculated with one of the colonies. The bacterial cultures were then allowed to grow on a shaker at 150 rpm for 2 days at 30±1° C. DNA was extracted from cells using QIAamp DNA Mini Kit (Cat. #51304, Qiagen, Toronto, Canada). The near full-length 16S rRNA gene was amplified using primers 27F (5′ AGA GTT TGA TCM TGG CTC AG 3′) and 1492R (5′ TAC GGY TAC CTT GTT ACG ACT T 3′). The polymerase chain reaction (PCR) protocol involved: 25 μL Dream Taq PCR mastermix (Cat. # K1071, Fisher Scientific, Montreal, Canada), 5 μL each primer (1 μM) (IDT, Coralville, TO, USA), 54 template DNA in a final 50 μL reaction volume.

The thermocycling conditions involved 95° C. for 3 min followed by 40 cycles of 95° C. for 30 sec, 55° C. for 30 sec, 72° C. for 1 min and final extension of 72° C. for 5 min. Amplification was checked by electrophoresis in a 1.5% agarose gel stained with SYBR® Safe DNA gel stain (Cat. # S33102, Thermo Fisher Scientific, Canada) and bands were visualized (Gel Doc EZ Imager, Bio-Rad, Hercules, Calif., USA). The sizes of the PCR fragments were compared against a 100-bp DNA ladder (Cat. #: 15628019; ThermoFisher Scientific, Canada). The 16S rRNA gene sequencing was done at Genome Quebec (McGill University and Genome Quebec Innovation Centre, Montreal, Canada), and compared with published 16S rRNA gene sequences using NCBI nucleotide Blast search. The forward and reverse sequences were aligned and a consensus sequence was created (TABLES 1-3).

The sequence analysis provided in TABLES 1-3 show that bacteria with antagonistic activity against Cmm have 99-100% sequence identity to 16s rRNA of Bacillus pumilus or Bacillus subtilis sequences provided by NCBI. Specifically, 1^{st} bacterium (ITI-1) was found to have 16s rRNA gene sequence with 100% identity and 100% coverage with Bacillus pumilus strain NES-CAP-1 (GenBank Accession No. MF079281.1); 2^{nd} bacterium (ITI-2) was found to have 16s rRNA gene sequence with 99% identity and 100% coverage with Bacillus subtilis strain BSFLG01 (GenBank Accession No. MF196314.1); and 3^{rd} bacterium (ITI-3) was found to have 16s rRNA gene sequence with 100% identity and 100% coverage with Bacillus subtilis strain SSL2 (GenBank Accession No. MH192382.1).

TABLE 1

| | 16s rRNA | Identification by |
|---|---|---|
| | gene sequence of the 1^{st} bacterium with | NCBI Nucleotide |
| Primers | antagonistic activity against Cmm (ITI-1) | BLAST Search |
| 27F | GAGCTTGCTCCCGGATGTTAGCGGCGGACGGGTGAGTAA | 100% identity and |
| 1492R | CACGTGGGTAACCTGCCTGTAAGACTGGGATAACTCCGG | 100% coverage with |
| | GAAACCGGAGCTAATACCGGATAGTTCCTTGAACCGCAT | Bacillus pumilus |
| | GGTTCAAGGATGAAAGACGGTTTCGGCTGTCACTTACAG | strain NES-CAP-1 |
| | ATGGACCCGCGGCGCATTAGCTAGTTGGTGAGGTAACGG | (GenBank Accession |
| | CTCACCAAGGCGACGATGCGTAGCCGACCTGAGAGGGT | No. MF079281.1) |
| | GATCGGCCACACTGGGACTGAGACACGGCCCAGACTCCT | |
| | ACGGGAGGCAGCAGTAGGGAATCTTCCGCAATGGACGA | |
| | AAGTCTGACGGAGCAACGCCGCGTGAGTGATGAAGGTTT | |
| | TCGGATCGTAAAGCTCTGTTGTTAGGGAAGAACAAGTGC | |
| | AAGAGTAACTGCTTGCACCTTGACGGTACCTAACCAGAA | |
| | AGCCACGGCTAACTACGTGCCAGCAGCCGCGGTAATACG | |
| | TAGGTGGCAAGCGTTGTCCGGAATTATTGGGCGTAAAGG | |
| | GCTCGCAGGCGGTTTCTTAAGTCTGATGTGAAAGCCCCC | |
| | GGCTCAACCGGGGAGGGTCATTGGAAACTGGGAAACTT | |
| | GAGTGCAGAAGAGGAGAGTGGAATTCCACGTGTAGCGG | |
| | TGAAATGCGTAGAGATGTGGAGGAACACCAGTGGCGAA | |
| | GGCGACTCTCTGGTCTGTAACTGACGCTGAGGAGCGAAA | |
| | GCGTGGGGAGCGAACAGGATTAGATACCCTGGTAGTCC | |
| | ACGCCGTAAACGATGAGTGCTAAGTGTTAGGGGGTTTCC | |
| | GCCCCTTAGTGCTGCAGCTAACGCATTAAGCACTCCGCC | |
| | TGGGGAGTACGGTCGCAAGACTGAAACTCAAAGGAATT | |
| | GACGGGGGCCCGCACAAGCGGTGGAGCATGTGGTTTAA | |
| | TTCGAAGCAACGCGAAGAACCTTACCAGGTCTTGACATC | |
| | CTCTGACAACCCTAGAGATAGGGCTTTCCCTTCGGGGAC | |
| | AGAGTGACAGGTGGTGCATGGTTGTCGTCAGCTCGTGTC | |
| | GTGAGATGTTGGGTTAAGTCCCGCAACGAGCGCAACCCT | |
| | TGATCTTAGTTGCCAGCATTCAGTTGGGCACTCTAAGGT | |
| | GACTGCCGGTGACAAACCGGAGGAAGGTGGGGATGACG | |
| | TCAAATCATCATGCCCCTTATGACCTGGGCTACACACGT | |
| | GCTACAATGGACAGAACAAAGGGCTGCGAGACCGCAAG | |
| | GTTTAGCCAATCCCACAAATCTGTTCTCAGTTCGGATCGC | |
| | AGTCTGCAACTCGACTGCGTGAAGCTGGAATCGCTAGTA | |
| | ATCGCGGATCAGCATGCCGCGGTGAATACGTTCCCGGGC | |
| | CTTGTACACACCGCCCGTCACACCACGAGAGTTGCAAC | |
| | ACCCGAAGTCGGTGAGGTAACC (SEQ ID NO: 1) | |

TABLE 2

| | 16s rRNA | Identification by |
|---|---|---|
| | gene sequence of the 2^{nd} bacterium with | NCBI Nucleotide |
| Primers | antagonistic activity against Cmm (ITI-2) | BLAST Search |
| 27F | GCAGTCGAGCGGACAGATGGGAGCTTGCTCCCTGATGTT | 99% identity and |
| 1492R | AGCGGCGGACGGGTGAGTAACACGTGGGTAACCTGCCT | 100% coverage with |
| | GTAAGACTGGGATAACTCCGGGAAACCGGGGCTAATAC | Bacillus subtilis |
| | CGGATGCTTGTTTGAACCGCATGGTTCAAACATAAAAGG | strain BSFLG01 |
| | TGGCTTCGGCTACCACTTACAGATGGACCCGCGGCGCAT | (GenBank Accession |
| | TANNTAGTTGGTGAGGTAACGGCTCACCAAGGCAACGAT | No. MF196314.1) |
| | GCGTAGCCGACCTGAGAGGGTGATCGGCCACACTGGGA | |
| | CTGAGACACGGCCCAGACTCCTACGGGAGGCAGCAGTA | |
| | GGGAATCTTCCGCAATGGACGAAAGTCTGACGGAGCAA | |
| | CGCCGCGTGAGTGATGAAGGTTTTCGGATCGTAAAGCTC | |
| | TGTTGTTAGGGAAGAACAAGTACCGTTCGAATAGGGCGG | |
| | TACCTTGACGGTACCTAACCAGAAAGCCACGGCTAACTA | |
| | CGTGCCAGCAGCCGCGGTAATACGTAGGTGGCAAGCGTT | |
| | GTCCGGAATTATTGGGCGTAAAGGGCTCGCAGGCGGTTT | |
| | CTTAAGTCTGATGTGAAAGCCCCCGGCTCAACCGGGGAG | |
| | GGTCATTGGAAACTGGGGAACTTGAGTGCAGAAGAGGA | |
| | GAGTGGAATTCCACGTGTAGCGGTGAAATGCGTAGAGAT | |
| | GTGGAGGAACACCAGTGGCGAAGGCGACTCTCTGGTCTG | |
| | TAACTGACGCTGAGGAGCGAAAGCGTGGGGAGCGAACA | |
| | GGATTAGATACCCTGGTAGTCCACGCCGTAAACGATGAG | |
| | TGCTAAGTGTTAGGGGGTTTCCGCCCCTTAGTGCTGCAG | |
| | CTAACGCATTAAGCACTCCGCCTGGGGAGTACGGTCGCA | |
| | AGACTGAAACTCAAAGGAATTGACGGGGGCCCGCACAA | |
| | GCGGTGGAGCATGTGGTTTAATTCGAAGCAACGCGAAG | |
| | AACCTTACCAGGTCTTGACATCCTCTGACAATCCTAGAG | |
| | ATAGGACGTCCCCTTCGGGGGCAGAGTGACAGGTGGTGC | |
| | ATGGTTGTCGTCAGCTCGTGTCGTGAGATGTTGGGTTAA | |
| | GTCCCGCAACGAGCGCAACCCTTGATCTTAGTTGCCAGC | |
| | ATTCAGTTGGGCACTCTAAGGTGACTGCCGGTGACAAAC | |
| | CGGAGGAAGGTGGGGATGACGTCAAATCATCATGCCCCT | |
| | TATGACCTGGGCTACACACGTGCTACAATGGACAGAACA | |
| | AAGGGCAGCGAAACCGCGAGGTTAAGCCAATCCCACAA | |
| | ATCTGTTCTCAGTTCGGATCGCAGTCTGCAACTCGACTGC | |
| | GTGAAGCTGGAATCGCTAGTAATCGCGGATCAGCATGCC | |
| | GCGGTGAATACGTTCCCGGGCCTTGTACACACCGCCCGT | |
| | CACACCACGAGAGTTTGTAACACCCGAAGTCGGTGAGGT | |
| | AACC (SEQ ID NO: 2) | |

TABLE 3

| | 16s rRNA | Identification by |
|---|---|---|
| | gene sequence of the 3^{rd} bacterium with | NCBI Nucleotide |
| Primers | antagonistic activity against Cmm (ITI-3) | BLAST Search |
| 27F | TAGTTGGTGAGGTAACGGCTCACCAAGGCAACGATGCGT | 100% identity and |
| 1492R | AGCCGACCTGAGAGGGTGATCGGCCACACTGGGACTGA | 100% coverage with |
| | GACACGGCCCAGACTCCTACGGGAGGCAGCAGTAGGGA | Bacillus subtilis |
| | ATCTTCCGCAATGGACGAAAGTCTGACGGAGCAACGCCG | strain SSL2 |
| | CGTGAGTGATGAAGGTTTTCGGATCGTAAAGCTCTGTTG | (GenBank Accession |
| | TTAGGGAAGAACAAGTACCGTTCGAATAGGGCGGTACCT | No. MH192382.1) |
| | TGACGGTACCTAACCAGAAAGCCACGGCTAACTACGTGC | |
| | CAGCAGCCGCGGTAATACGTAGGTGGCAAGCGTTGTCCG | |
| | GAATTATTGGGCGTAAAGGGCTCGCAGGCGGTTTCTTAA | |
| | GTCTGATGTGAAAGCCCCCGGCTCAACCGGGGAGGGTCA | |
| | TTGGAAACTGGGGAACTTGAGTGCAGAAGAGGAGAGTG | |
| | GAATTCCACGTGTAGCGGTGAAATGCGTAGAGATGTGGA | |
| | GGAACACCAGTGGCGAAGGCGACTCTCTGGTCTGTAACT | |
| | GACGCTGAGGAGCGAAAGCGTGGGGAGCGAACAGGATT | |
| | AGATACCCTGGTAGTCCACGCCGTAAACGATGAGTGCTA | |
| | AGTGTTAGGGGGTTTCCGCCCCTTAGTGCTGCAGCTAAC | |
| | GCATTAAGCACTCCGCCTGGGGAGTACGGTCGCAAGACT | |
| | GAAACTCAAAGGAATTGACGGGGGCCCGCACAAGCGGT | |
| | GGAGCATGTGGTTTAATTCGAAGCAACGCGAAGAACCTT | |
| | ACCAGGTCTTGACATCCTCTGACAATCCTAGAGATAGGA | |
| | CGTCCCCTTCGGGGGCAGAGTGACAGGTGGTGCATGGTT | |
| | GTCGTCAGCTCGTGTCGTGAGATGTTGGGTTAAGTCCCG | |
| | CAACGAGCGCAACCCTTGATCTTAGTTGCCAGCATTCAG | |
| | TTGGGCACTCTAAGGTGACTGCCGGTGACAAACCGGAGG | |
| | AAGGTGGGGATGACGTCAAATCATCATGCCCCTTATGAC | |
| | CTGGGCTACACACGTGCTACAATGGACAGAACAAAGGG | |
| | CAGCGAAACCGCGAGGTTAAGCCAATCCCACAAATCTGT | |
| | TCTCAGTTCGGATCGCAGTCTGCAACTCGACTGCGTGAA | |
| | GCTGGAATCGCTAGTAATCGCGGATCAGCATGCCGCGGT | |
| | GAATACGTTCCCGGGCCTTGTACACACCGCCCGTCACAC | |
| | CACGAGAGTTTGTAACACCCGAAGTCGGTGAGGTAACC | |
| | (SEQ ID NO: 3) | |

### 4.5.3.2.Example 3-2: Identification of the Microbes Based on Api Tests

API 50 CHB/E Medium (Biomerieux 50 430) is intended for the identification of Bacillus and related genera. It is a ready-to-use medium which allows the fermentation of the 49 carbohydrates on the API 50 CH strip. A bacterial suspension of the test microorganism is made in the medium and each tube of the strip is then inoculated with the suspension. During incubation, the carbohydrates are fermented to acids which result in a decrease of the pH, detected by change in color of the indicator.

Three strains of bacteria identified as Bacillus subtilis (ITI-2 and ITI-3) and Bacillus pumilus (ITI-1) in Example 3-2 (their 16S rRNA gene sequences are provided in TABLES 1-3) were streaked onto LBA plates and incubated at 30° C. for 48 hours. Several colonies from the pure culture were suspended in an ampule of API NaCl 0.85% (2 ml) in order to prepare a turbid bacterial suspension. A second ampule of API NaCl 0.85% was used in order to prepare a suspension with a turbidity equivalent to McFarland 2 by transferring certain number of drops from the previous suspension, recording the number of drops used (n). Inoculation of API 50 CHB/E ampule was performed by transferring twice the number of drops of suspension (2n) into the ampule followed by thorough mixing. The API 50 CHB/E Medium was then transferred to the gallery by filling all the 49 tubes, followed by incubation for 48 hours (±2 hours) @ 30° C. and then scored for activity according the manufacturer's instructions. A positive test corresponds to acidification revealed by the phenol red indicator contained in the medium changing to yellow. For the Aesculin test, a change in color from red to black was observed. Microbial identification was performed by entering the test results (positive or negative tests) in the apiweb identification website, apiweb.biometrieux.com. Results from the apiweb identification site are provided below in TABLE 4.

TABLE 4

| | | | Bacillus | Bacillus | Bacillus |
|---|---|---|---|---|---|
| Test | Abbre- | | pumilus | subtilus | subtilus |
| #. | viation¹ | Substrate² | (ITI-1) | (ITI-2) | (ITI-3) |
| 1 | GLY | Glycerol | + | + | + |
| 2 | ERY | Erythritol | − | − | − |
| 3 | DARA | D-Arabinose | − | − | − |
| 4 | LARA | L-Arabinose | + | + | + |
| 5 | RIB | Ribose | + | + | + |
| 6 | DXYL | D-Xylose | − | + | + |
| 7 | LXYL | L-Xylose | − | − | − |
| 8 | ADO | Adonitol | − | − | − |
| 9 | MDX | β-Methylxyloside | − | − | − |
| 10 | GAL | Galactose | − | − | − |
| 11 | GLU | D-Glucose | + | + | + |
| 12 | FRU | D-Fructose | + | + | + |
| 13 | MNE | D-Mannose | + | + | + |
| 14 | SBE | L-Sorbose | − | − | − |
| 15 | RHA | Rhamnose | − | − | − |
| 16 | DUL | Dulcitol | − | − | − |
| 17 | INO | Inositol | − | + | + |
| 18 | MAN | Mannitol | + | + | + |
| 19 | SOR | Sorbitol | − | + | + |
| 20 | MDM | α-Methyl- | − | − | − |
| | | D-mannoside | | | |
| 21 | MDG | α-Methyl- | − | + | + |
| | | D-glucoside | | | |
| 22 | NAG | N-Acetyl- | + | − | − |
| | | glucosamine | | | |
| 23 | AMY | Amygdalin | + | + | + |
| 24 | ARB | Arbutin | + | − | − |
| 25 | ESC | Aesculin | + | + | + |
| 26 | SAL | Salicin | + | − | − |
| 27 | CEL | Cellobiose | + | + | + |
| 28 | MAL | Maltose | − | + | + |
| 29 | LAC | Lactose | − | − | − |
| 30 | MEL | Melibiose | − | + | + |
| 31 | SAC | Sucrose | + | + | + |
| 32 | TRE | Trehalose | + | + | + |
| 33 | INU | Inulin | − | + | + |
| 34 | MLZ | Melezitose | − | − | − |
| 35 | RAF | D-Raffinose | − | + | + |
| 36 | AMD | Starch | − | + | + |
| 37 | GLYG | Glycogen | − | + | + |
| 38 | XLT | Xylitol | − | − | − |
| 39 | GEN | β-Gentiobiose | − | − | − |
| 40 | TUR | D-Turanose | − | + | − |
| 41 | LYX | D-Lyxose | − | − | − |
| 42 | TAG | D-Tagatose | + | − | − |
| 43 | DFUC | D-Fucose | − | − | − |
| 44 | LFUC | L-Fucose | − | − | − |
| 45 | DARL | D-Arabitol | − | − | − |
| 46 | LARL | L-Arabitol | − | − | − |
| 47 | GNT | Gluconate | − | − | − |
| 48 | 2KG | 2-Ketogluconate | − | − | − |
| 49 | 5KG | 5-Ketogluconate | − | − | − |

¹(Ref. 50 430; API 50 CHB/E Medium; Biomerieux Inc., Durham, NC, USA)
²Logan N A & R C W Berkeley. 1984. Identification of Bacillus strains using the API system. J. Gen. Microbiol. 130: 1871-1882.
+ stands for Positive Reaction;
− stands for Negative Reaction

The API test showed that one strain has activity 99.9% similar to Bacillus pumilus and two strains have activity 99.8 or 99.9% similar to Bacillus subtilis. These results confirmed that one strain identified to have antagonistic activity against Cmm is Bacillus pumilus (ITI-1) and two strains are Bacillus subtilis (ITI-2 and 3).

Thus, based on both 16S rRNA gene sequencing and API test, the isolates were identified as Bacillus pumilus (ITI-1), Bacillus subtilus (ITI-2) and Bacillus subtilus (ITI-3) as summarized below in TABLE 5.

TABLE 5

| | 16S rRNA gene sequencing | | API 50 CHB | |
|---|---|---|---|---|
| | Identifi- | Similarity | Identifi- | Similarity |
| Bacterium | cation | (%) | cation | (%) |
| Bacillus ITI-1 | Bacillus | 100% | Bacillus | 99.9% |
| | pumilus | | pumilus | |
| Bacillus ITI-2 | Bacillus | 99% | Bacillus | 99.8% |
| (small) | subtilis | | subtilis | |
| Bacillus ITI-3 | Bacillus | 100% | Bacillus | 99.9% |
| (large) | subtilis | | subtilis | |

### 4.5.4. Example 4: Antimicrobial Activity of Bacillus Pumilus and Bacillus Subtilus Against Cmm

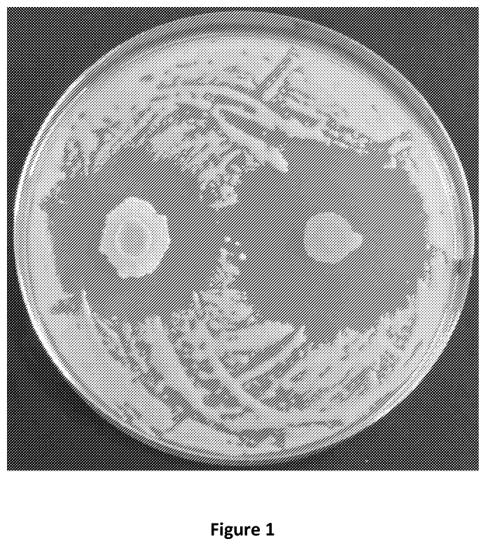

Bacillus pumilus and Bacillus subtilus identified above in Example 3 were streaked on LBA and incubated at 30° C. Single cell colonies from this culture were further grown in LB broth and incubated on a shaker at 150 rpm at 30° C. for 24 h. Single colony of Cmm growing on NBYA plate was inoculated into test tube containing Nutrient Broth and incubated at 28° C. for 48 h while being shaken at 150 rpm on an orbital shaker. A suspension of 100 μL of this culture (Cmm) was evenly spread over fresh NBYA plates using sterile spreader. A 10 μL drop of overnight culture of B. pumilus and B. subtilis (as described above) were spotted onto the NBYA lawn of Cmm and incubated for 3 days at 28° C. A zone of inhibition surrounding B. pumilus (right) and B. subtilis (left) colonies demonstrated antibacterial activity against Cmm (FIG. 1).

In addition, the antibacterial activity of various fractions and the purified antibiotic produced by B. pumilus was assessed via agar well diffusion assay. Cmm was grown as described above and a suspension of 100 μL was evenly spread over fresh NBYA plates using sterile spreader. Wells of 6 mm diameter were carefully made in the agar and 50 μL of the test fraction or antibiotic test sample extracted from B. pumilus was poured into the agar well. Sterilized distilled water served as a control treatment. The petri plates were incubated at 28° C. for 3 days and observed for zone of inhibition around the well. A clear zone of inhibition around the well indicated antibacterial activity against Cmm (FIG. 6).

### 4.5.5. Example 5: Extraction, Purification, and Identification of the Antibiotic Produced by Bacillus Pumilus

A 5 day-old bacterial culture of Bacillus pumilus was harvested and the antimicrobial compound isolated by phase partitioning the bacterial culture with 40% butanol while being shaken for 30 min (150 rpm). The butanol mixture was then allowed to stand overnight at 4° C. to phase partition butanol. The top butanol layer containing the antimicrobial compound was carefully collected and concentrated to dryness at 50° C. under vacuum by rotary evaporation (Yamato RE500; Yamato, Calif., USA).

The concentrated material (crude extract) in the vessel was suspended in 10% acetonitrile (AcN/H₂O, v/v) and frozen at −20° C. until further analysis. The crude extract was centrifuged (Sorvall Biofuge Pico, Mandel Scientific, ON, Canada) at 13,000 rpm for 30 min to remove insoluble particles. The supernatant was filter sterilized (PVDF, 0.45 μm, Fisher Scientific, Montreal, Canada) and tested for biological activity against Cmm. The filtered extract was then loaded onto a C18 column (Restek™, Fisher Scientific, Montreal, Canada) and eluted with 20 mL of 10%, 20%, 40%, 60%, 80% and 100% acetonitrile and the fractions were collected. The eluted fractions under various concentrations of acetonitrile were lyophilized (SNL216V, Savant Instruments Inc., NY, USA), suspended in sterilized distilled water and tested for biological activity against Cmm. The fraction showing an inhibition zone against Cmm was selected for further fractionation by HPLC. The active fraction was stored in sterilized vials at 4° C. prior to HPLC analysis.

The fraction showing biological activity against Cmm in-vitro was further fractionated by HPLC (Waters Corporation, USA). The HPLC system was equipped with a Vydac C18 reversed-phase column (4.6×250 mm, 5 μm; cat. #218TP 5, Vydac, Calif., USA) and fitted with waters 1525 Binary HPLC pump, a waters 2487 dual λ absorbance detector (Waters Corporatrion, USA) set at 214 nm and a WISP 712 autosampler. Prior to HPLC analysis the samples were centrifuged at 13,000 rpm for 10 min and 100 μL of the active fraction was subjected to HPLC analysis. Chromatography was conducted for 60 min using acetonitrile and water as solvents with a flow rate of 1 mL/min. The elution was carried out using a gradient of 10-95% acetonitrile (v/v) from 0-50 min, 95-10% acetonitrile from 50-52 min and finally at 10% acetonitrile from 52-60 min. Fractions were collected at 1-min intervals.

An HPLC chromatogram was generated and one-minute fractions corresponding to peaks appeared in the chromatogram were collected, lyophilized in order to remove acetonitrile, resuspended in sterilized water and tested for biological activity against Cmm by agar-well diffusion assay as described earlier. Fractions showing antibacterial activity against Cmm in-vitro were pooled together and subjected to another round of HPLC purification, freeze drying and biological activity assessment until a single pure peak was achieved. The purified active material eluting as a single peak was collected and stored at 4° C. until further analyzed by mass spectrometry.

Liquid Chromatography Electrospray Ionization MS (LC-ESI-MS):

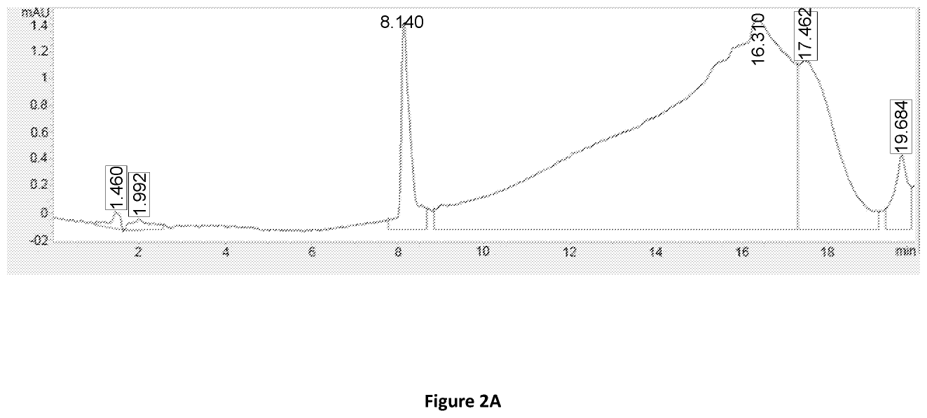

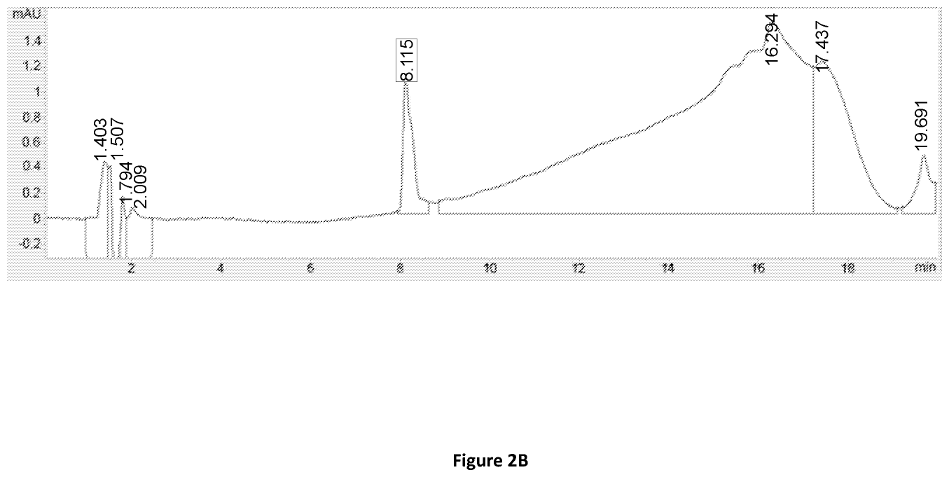

LC-ESI-MS analysis was performed over the mass range of m/z 50-2000 by passing the purified sample through a Spurcil C18 column (Dikma Technologies Inc., Canada; Cat. #: 82013) (2.1×150 mm, 3 μm particle size) using Acetonitrile/H₂O/0.1% (v/v) formic acid on an Agilent 1100 HPLC system, coupled with LTQ Orbitrap Velos with ETD (Thermo Fisher Scientific) ion trap mass spectrometer in positive ion mode. The sample was run with a gradient of 10-95% acetonitrile for 17.0 min followed by 95-10% acetonitrile for 2.0 min and finally isocratic at 10% acetonitrile for 1.0 min. The flow rate was 0.2 mL/min with a run time of 20 min (FIGS. 2A-B and 3A-B). HPLC chromatogram of the purified fraction from Bacillus pumilus (FIG. 2A) was compared with HPLC chromatogram of the standard Micrococcin P1 purchased from Bioaustralis Fine Chemcials (Smithfield, NSW, Australia) (FIG. 2B).

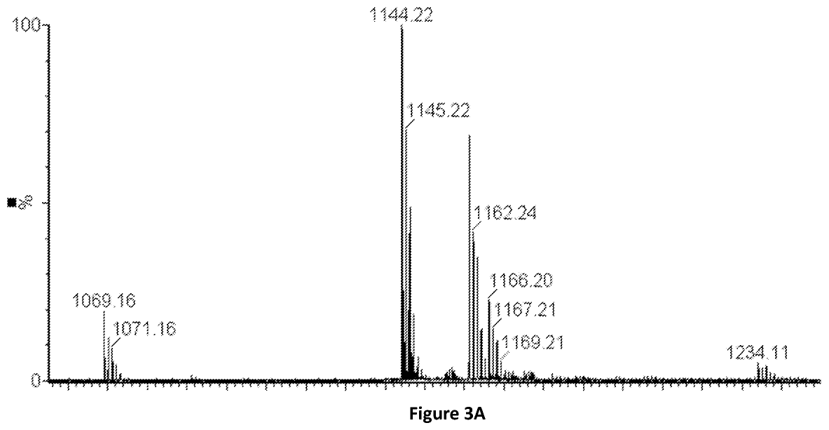

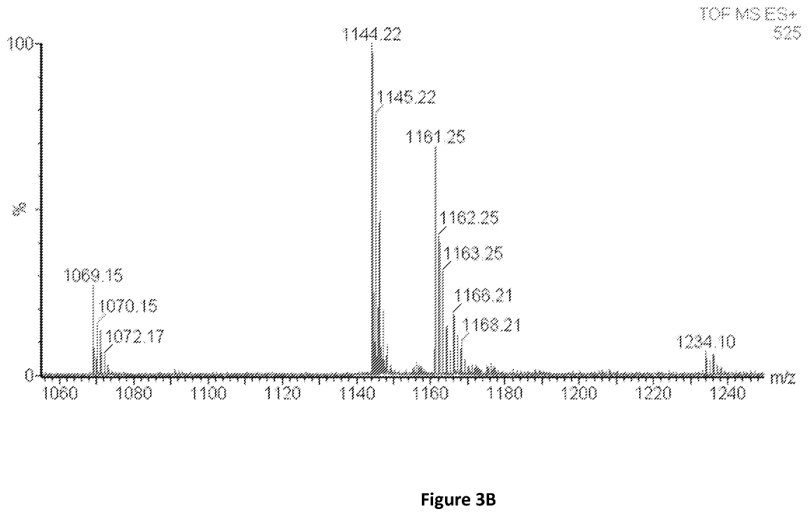

LC-MS chromatogram was further compared between the Bacillus pumilus active fraction (FIG. 3A) and standard Micrococcin P1 (FIG. 3B). LC-MS chromatorgram of the analyzed Bacillus pumilus active fraction revealed three peaks of Micrococcin P1 homologues which corresponded to m/z 1,144.22 [M+H]⁺, m/z 1,161.25 [M+NH₄]⁺, m/z 1,166.22 [M+Na]⁺ (FIG. 3A). LC-MS chromatogram of the standard Micrococcin P1 showed m/z 1,144.22 [M+H]⁺, m/z 1,161.25 [M+NH₄]⁺, m/z 1,166.21 [M+Na]⁺ (FIG. 3B). When tested for biological activity, the standard Micrococcin P1 also showed antimicrobial activity against Cmm.

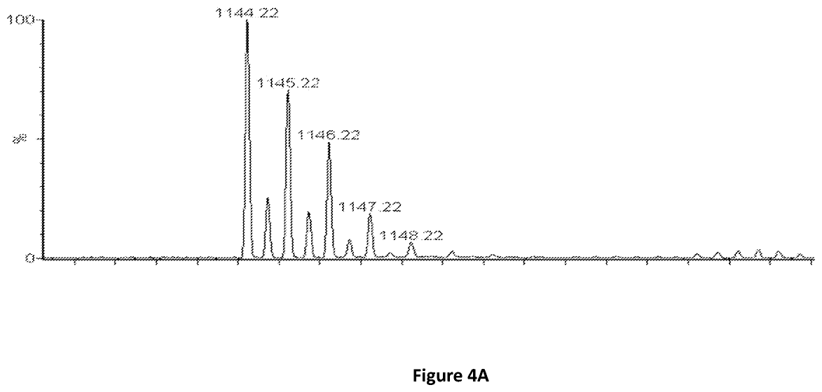

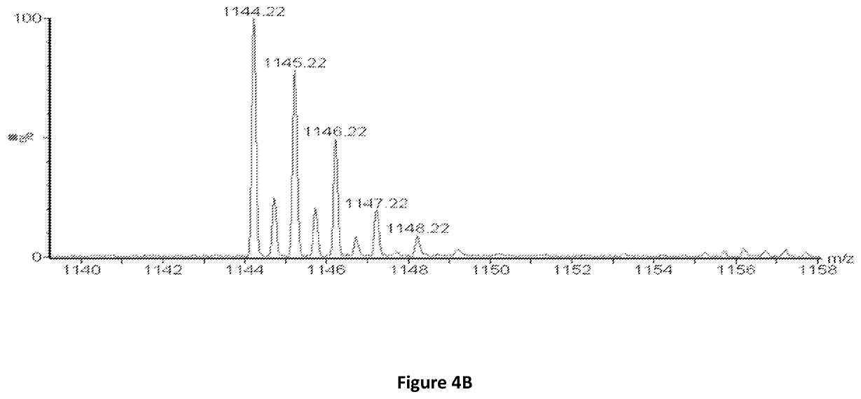

ESI-MS spectrum of the purified fraction from Bacillus pumilus (FIG. 4A) was also compared with ESI-MS spectrum of the standard Micrococcin P1 (FIG. 4B).

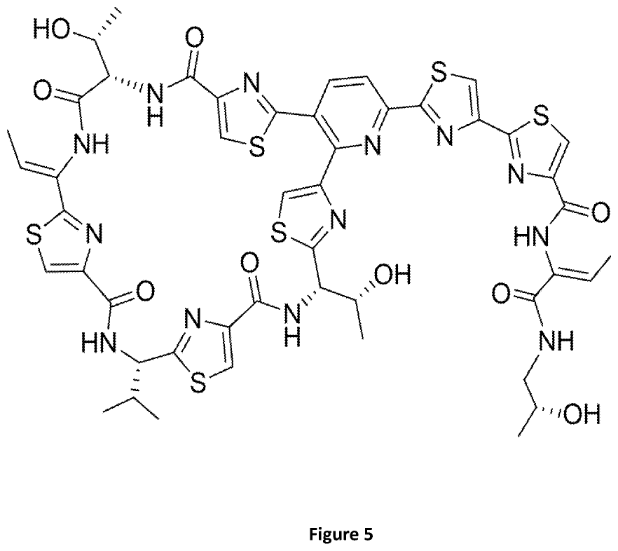

HPLC chromatogram, LC-MS chromatogram, and ESI-MS spectrum were identical between the purified fraction from Bacillus pumilus (FIGS. 2A, 3A, and 4A) and standard Micrococcin P1 (FIGS. 2B, 3B, and 4B), suggesting that the antibiotic in the purified fraction is Micrococcin P1 (FIG. 5).

### 4.5.6. Example 6: Dose Dependent Antibacterial Activity of Micrococcin P1

The antimicrobial activities of Micrococcin P1 at various concentrations were assessed via agar well diffusion assay. A cell suspension of Cmm was overlaid on NBYA and the plates were allowed to air dry. A 50 μL drop of Micrococcin P1 diluted in various concentrations were applied into agar well. The petri plates were incubated for 3 days 28° C. and then the the bacterial lawns were observed to measure growth inhibition zones around the application of Micrococcin P1.

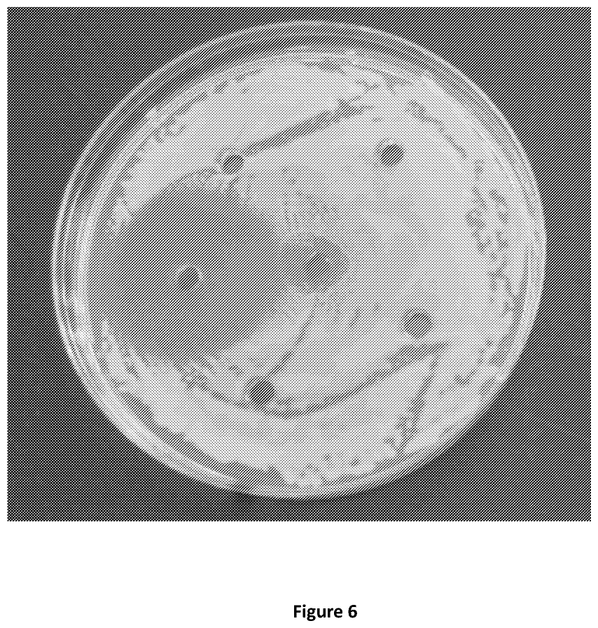

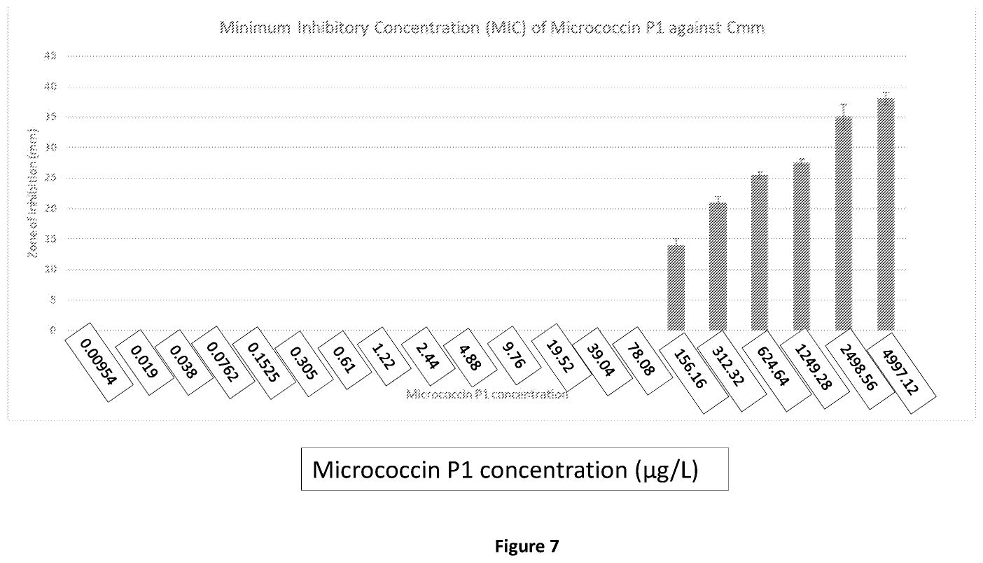

Micrococcin P1 demonstrated antibacterial activities, providing growth inhibition zones on the plate only when applied at 7.8125 ng or more per well in a 50 μL, which is at a concentration greater than 0.156 mg/L (i.e., 137 nM). The antibacterial activities increased proportional to the Micrococcin P1 concentrations (FIG. 7), having the most significant effects at 5 mg/L (i.e., 4.37 μM) concentration, which is the highest concentration tested in the experiment.

These results confirm that Micrococcin P1 is the antibacterial composition and Micrococcin P1 has to be present above a minimal concentration 0.156 mg/L (i.e., 137 nM) to provide the antibacterial activities against Cmm on the LBA plate.

### 4.5.7. Example 8: Pot Experiment

### 4.5.7.1.Materials and Methods

A tomato biocontrol experiment was conducted to test the efficacy of Bacillus strains against infection of Cmm in tomato plants by real-time PCR quantification.

Bacterial growth and culture conditions: Cmm was grown in Nutrient Broth Yeast Extract (YBYE) medium and incubated at 28° C. at 120 rpm for 72 hours. The composition of the NBYE included nutrient broth (8 g/L), K₂HPO₄ (2 g/L), KH₂PO₄ (0.5 g/L), yeast extract (2 g/L), 20% glucose (25 ml/L) and 1M MgSO₄.7H₂O (1 mL/L). Glucose and MgSO₄.7H₂O solutions were autoclaved separately and mixed with the other ingredients before plating (˜50° C.). The two experimental biocontrol agents (B. subtilis and B. pumilus) were grown in Luria-Bertani (LB) medium for 24 hours at 30° C., shaken at 120 rpm. The composition of LB medium included Bacto-tryptone (10 g/L), yeast extract (5 g/L) and NaCl (5 g/L). Agar was added @ 15 g/L when the microorganisms were grown on agar media. For tomato plant inoculation experiments, bacteria were grown in their respective broth media, subsequently pelleted by centrifugation, re-suspended in saline water (0.85% NaCl) and the cell density was adjusted to approx. 10×⁸ CFU/mL.

Tomato seedling production: Seeds of tomato cultivar Sub Artic Maxi (Stokes Seeds, ON, Canada) were surface sterilized in 25% commercial bleach solution for 3 minutes. The seeds were then washed carefully with sterile water several times to remove the bleach solution and grown in a growth chamber set at 25° C., 16-hour photoperiod and watered/fertilized regularly as needed.

Plant inoculation: Seedlings (4 weeks old) were transferred to plastic pots (500 mL capacity) filled with Agromix potting mixture (Teris, Laval, Quebec, Canada) and divided into the following treatments: 1) control (not inoculated, negative control), 2) Cmm only (positive control); 3) B. pumilus+Cmm, 4) B. subtilis+Cmm, 5) Mix (1:1 mixture of B. subtilis and B. pumilus)+Cmm. Tomato plants were carefully removed from the growth medium, roots exposed and washed with sterile water followed by dipping for 1 minute in their respective bacterial treatments. The experiment was performed twice. For the first experiment (Experiment I in Table 6), each treatment mixture contained 2.0×10⁸ CFU/mL of Cmm, 2.5×10⁸ CFU/mL of B. subtilis, and/or 4.0×10⁸ cfu/mL of B. pumilus. For the second experiment (Experiment II in Table 6), each treatment mixture contained 8.5×10⁸ CFU/mL of Cmm, 1.8×10⁸ CFU/mL of B. subtilis, and/or 7.4×10⁸ CFU/mL of B. pumilus. Control plants were uprooted but not inoculated. Each treatment was replicated 3 times.

TABLE 6
Inoculum density of microorganisms used in the study

| Strains | Experiment I (CFU/mL) | Experiment II (CFU/mL) |
|---|---|---|
| Cmm | 2.0 × 10⁸ | 8.5 × 10⁸ |
| B. subtilis | 2.5 × 10⁸ | 1.8 × 10⁹ |
| B. pumilus | 4.0 × 10⁸ | 7.4 × 10⁸ |

Plant tissue sampling procedure: Tomato plants were harvested at 4, 10 and 21 days after inoculation (DAI). Tissue samples were taken from leaf, stem and root and surface sterilized by dipping in 75% alcohol for 1 minute, washed with sterile water and dried with sterile blotting paper. Two hundred (200) mg of each plant tissue samples (leaf, stem and root) were excised and stored in sterile cryogenic tubes at −80° C. Plant tissue samples were taken, as follows:

### 4 DAL

Root: 3 cm under crown region

Stem: 3 cm above the crown region (representing middle of the plant)

Leaf: Second leaflet aseptically cut

### 10 DAI:

Root: 3 cm under crown region

Stem: Cut between 2 and 3 leaf of the plant (representing middle of the plant)

Leaf: Third leaflet aseptically cut

### 21 DAL

Root: 3 cm under crown region

Stem: Cut between 6 and 7 leaf of the plant (representing middle of the plant)

Leaf: Seventh leaflet aseptically cut

DNA extraction: Plant tissue (200 mg) was macerated, with 1 mL phosphate buffered saline (PBS), to homogeneity using sterile mortar and pestle, transferred to a sterile cryogenic tube and used for total DNA extraction. Total DNA from the plant tissue was extracted using DNeasy PowerSoil Kit (Qiagen, Cat. #: 12888-100). Extracted total DNA was quantified with Nano drop (Thermo Scientific™ Nanodrop™ One/OneC Microvolume) and diluted in elution buffer to 3-5 ng/μl; extracted DNA from all plant tissues were diluted to this range in order to normalize the DNA concentration for all samples. The extracted DNA was stored at 4° C. until further use.

Target gene and specificity of the PCR assay: Amplification of the CelA target gene, specific for Cmm, was performed on genomic DNA extracted from Cmm, B. subtilis and B. pumilus cultures in order to verify that the primers were specific for Cmm only.

DNA was extracted from the three microbes (Cmm, B. subtilis and B. pumilus) using QIAamp DNA Mini Kit (Cat. #51304, Qiagen, Toronto, Canada). The CelA gene (136 bp product) was amplified using primers CelAfw (5′ GGT TCT CCG CAT CAA ACT ATC C 3′) and CelArv (5′ TGC TTG TCG CTC GTC 3′). The polymerase chain reaction (PCR) protocol involved: 25 μL Dream Taq PCR mastermix (Cat. # K1071, Fisher Scientific, Montreal, Canada), 5 μL each primer (1 μM) (IDT, Coralville, TO, USA), 54 template DNA in a final 50 μL reaction volume. The thermocycling conditions involved 95° C. for 3 min followed by 40 cycles of 95° C. for 30 sec, 55° C. for 30 sec, 72° C. for 1 min and final extension of 72° C. for 5 min. Amplification was checked by electrophoresis in a 1.5% agarose gel stained with SYBR® Safe DNA gel stain (Cat. # S33102, Thermo Fisher Scientific, Canada) and bands were visualized (Gel Doc EZ Imager, Bio-Rad, Hercules, Calif., USA). The sizes of the PCR fragments were compared against a 100-bp DNA ladder (Cat. #: 15628019; ThermoFisher Scientific, Canada). Sequencing of the CelA PCR product was conducted at Genome Quebec (McGill University and Genome Quebec Innovation Centre, Montreal, Canada), and compared with published target sequences using NCBI nucleotide Blast search (BLASTn).

Sensitivity test of the CelA real-time PCR assay and standard curve generation: A standard curve was performed using DNA extracted from spiked tomato plant tissue (leaf, stem and root) with a known Cmm concentration. A serial ten-fold dilution of the extracted DNA was used for standard curve generation. The real-time PCR assay was performed in 20 μL final reaction volume containing 5 μL of DNA, 2 μL of each CelA primer (final concentration 1.25 μM) and 10 μL of SYBR Green PCR Master Mix. The thermal profile was 95° C. for 3 min, 35 cycles of 95° C. for 15 sec and 62.5° C. for 15 sec followed by 72° C. for 30 sec.

Real-time PCR amplification of CelA gene for the detection and quantification of Cmm in tomato plants: Real-time PCR was performed in a Bio-Rad CFX96 real-time PCR System running software CFX Manager™ version 3.1 (Bio-Rad). Amplification and detection were performed in 96-well optical plates (Bio-Rad hard-shell) with SYBR-Green PCR Master Mix (Sso Advanced™ Universal SYBR® Green Supermix, Cat. #. 1725271). All amplifications were performed in duplicate in a final volume of 20 μL containing 5 μL of the total DNA, 2 μL of each CelA primer (final concentration of 1.25 μM), and 10 μL SYBR Green PCR Master Mix. The cycling program consisted of an initial denaturation of 3 min at 95° C., followed by 35 cycles of 15 sec at 95° C., 15 sec at 62.5° C., and 30 sec at 72° C.

To check for specificity, melting curve (Tm) analysis was performed by raising the temperature from 70 to 95° C. (in 0.2° C. increments) with continuous monitoring of fluorescence. Melting curve analysis was conducted in order to ensure the absence of nonspecific products and primer dimers. Two negative controls and a series of tenfold dilutions of the total DNA were used as a template to construct calibration curves.

### 4.5.7.2.Results and Conclusions

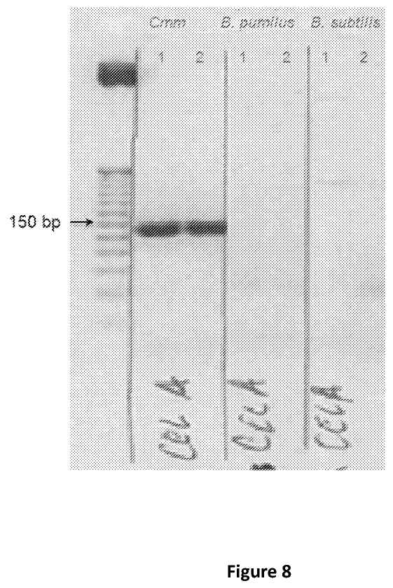

Specificity of CelA gene primers for Cmm: In order to verify specificity of CelA gene primers for Cmm, DNA was extracted from Cmm, B. pumilus and B. subtilis, and amplified using PCR. When the PCR products were run on an agarose gel, a CelA product band was only observed for Cmm, while there were no bands detected for B. pumilus and B. subtilis representing lack of PCR amplification of the CelA target gene (FIG. 8). The amplified PCR product from Cmm was sequenced using Sanger Sequencing and revealed a fragment of 136 bp including forward and reverse primer sequences (SEQ ID NO: 7). Using NCBI nucleotide BLAST search, the fragment showed 100% identity to the reported sequence for Cmm CelA gene (GenBank Accession No.: KJ123730.1) (SEQ ID NO: 8).

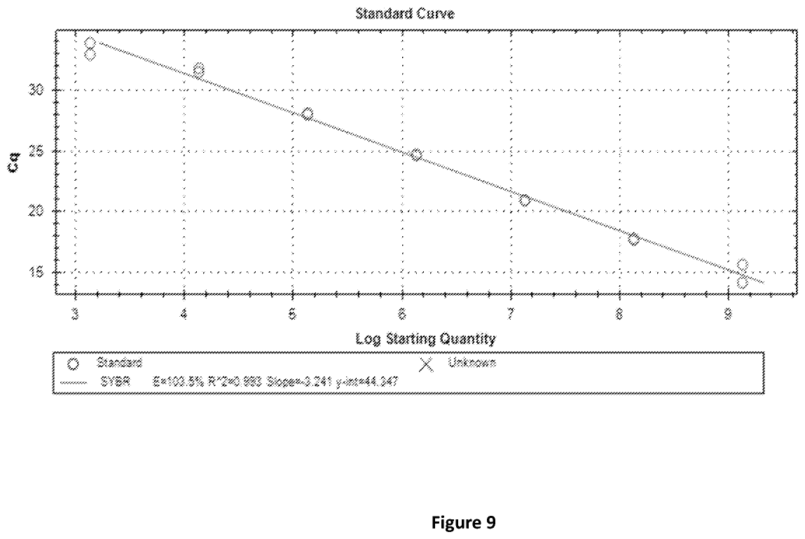

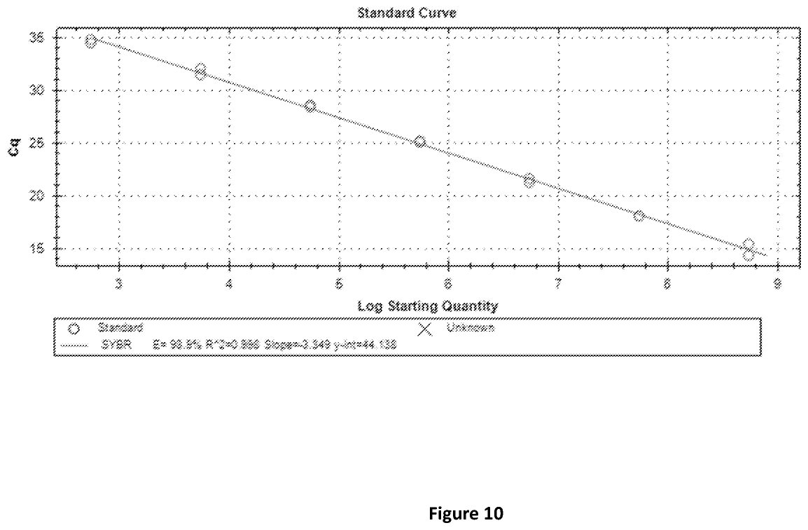

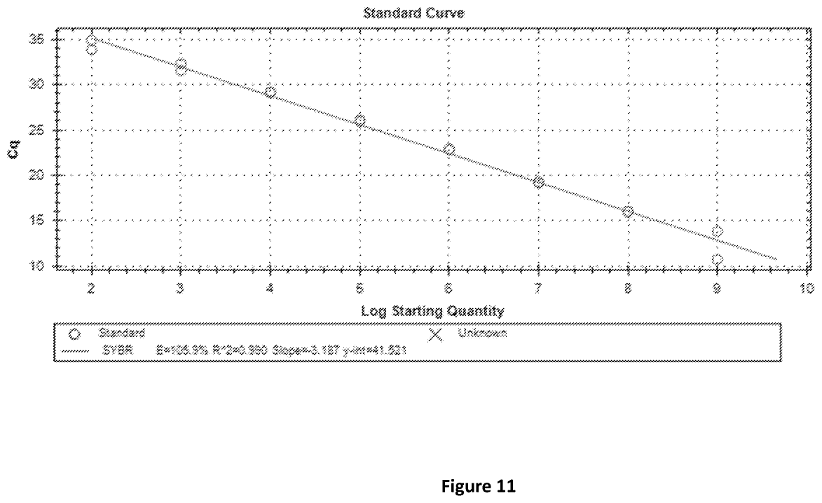

Real-time PCR standard curve: A standard curve was constructed, based on detection of the CelA gene, for each plant tissue in order to correlate the population of Cmm with a cycle of amplification. All standard curves had an efficiency within the recommended range (90-110%), and R² larger than 0.99 (Taylor et al., 2010). Straight-line regressions were obtained from 10-fold serial dilutions of DNA samples which were extracted from macerated tomato plant tissue spiked with a known concentration of Cmm. Linear equations with a correlation co-efficient (R²) larger than 0.99 were obtained for the three tissues (FIGS. 9, 10, and 11). FIG. 9 is a standard curve of Cmm from leaf tissue, FIG. 10 is from stem tissue and FIG. 11 is from root tissue. The detection limit of the real-time PCR assay was 10³ CFU/g for leaf, stem and root tissues.

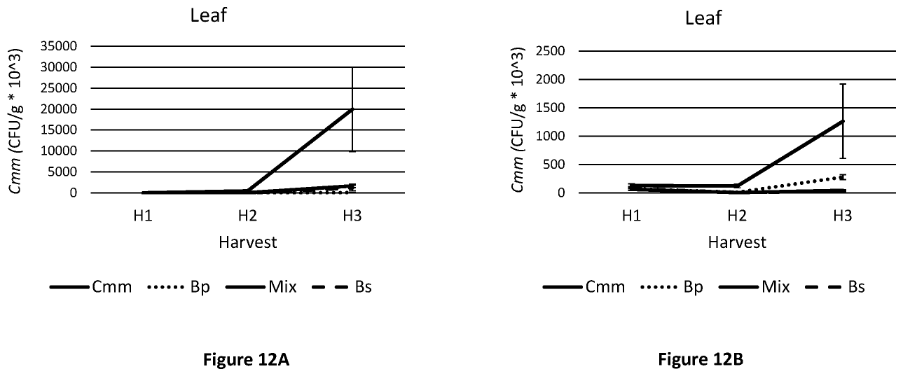

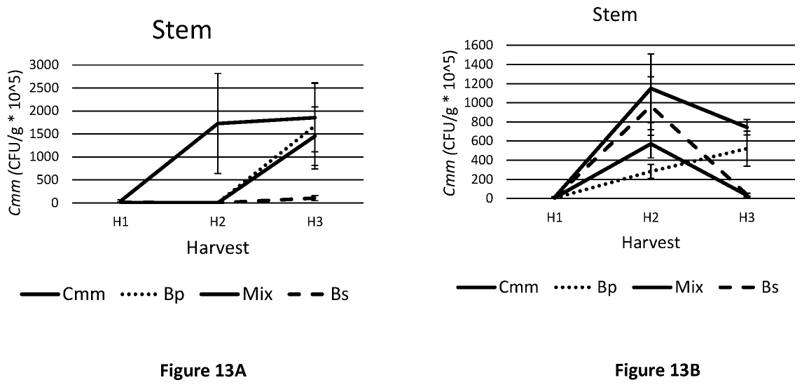

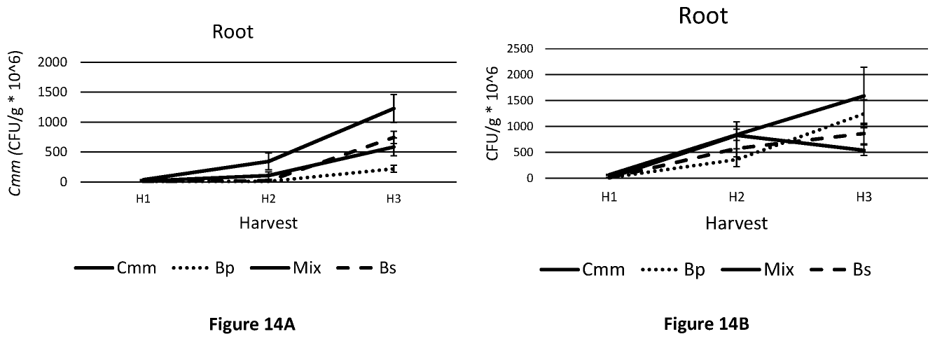

Detection and quantification of Cmm by real-time PCR: The CelA target gene was not detected in the negative controls (plants not inoculated), in both experiments, as evident by absence of amplification product. On the other hand, the CelA target gene was detected in all treatments inoculated with Cmm. Additionally, the estimated Cmm CFU/g (calculated from the CelA gene standard curves) in the positive controls (plants inoculated with Cmm only) (FIGS. 12A-14B) were higher at all harvest times and tissues as compared to other treatments (B. pumilus, B. subtilis or Mix).

Cmm populations were detected in all plant tissues, even at the earliest harvest time (4 DAI). The highest levels of Cmm were found at the root, followed by stem and leaf. This is not surprising as plants were inoculated at the root level. Both experiments, showed similar trends for all treatments, tissues and harvest times. However, slight differences in the Cmm populations were observed for the two experiments—results from Experiment I (Table 6) are provided in FIGS. 12A, 13A and 14A and results from Experiment II (Table 6) are provided in FIGS. 12B, 13B and 14B. The differences could be explained by the slight differences in the inoculum densities that plants received.

When applied to tomato roots in the presence of Cmm, B. subtilis alone, B. pumilus alone, or the mixture of the two microbes (1:1) inhibited the spread of Cmm in all tissues inside the tomato plants. Results from this study support the hypothesis that the experimental biocontrol Bacillus spp. reduce the amount of Cmm in tomato seedlings. This study highlights the importance of the two Bacillus spp. strains as biological control agents for Cmm. Indeed, disease symptoms caused by Cmm appear only when bacteria reach a titer of 10⁸-10⁹ CFU/g in plant tissue (Meletzus et al., 1993; Gartemann et al., 2003). Therefore, reducing the number of pathogenic bacteria is an important strategy in disease management and avoiding wilt and canker of tomato plants.

### 4.5.8. Example 10: Field Experiment

Tomato biocontrol products are tested in the fields planted with tomatoes infected with Cmm at least 10⁸-10⁹ CFU/g. Fields are are divided into four groups, and treated with water (control), or different amounts of BS (Bacillus subtilus), BP (Bacillus pumilus), or BS+BP (B. subtilus+Bacillus pumilus).

Yields, marketable yields, and symptoms of Cmm infections are measured in tomatoes from each group. Tomatoes treated with Bacillus subtilus, Bacillus pumilus or both are better than the control group in all three metrics: yields, marketable yield and symptoms of Cmm infections. Furthermore, effective amounts of Bacillus subtilus, Bacillus pumilus or both for protecting tomatoes from Cmm infections are identified.

### 4.5.9. Example 11: Field Experiment

Tomato biocontrol products further containing a cell-free supernatant of a microbial culture, IN-Ml, are tested in the fields planted with tomatoes infected with Cmm at least 10⁸-10⁹ CFU/g. Fields are divided into four groups and treated with water (control), or different amounts of BS (Bacillus subtilus), BP (Bacillus pumilus), or BS+BP (B. subtilis+Bacillus pumilus) mixed with a cell-free supernatant of microbial culture, IN-M1.

Yields, marketable yields, and symptoms of Cmm infections are measured in tomatoes from each group. Tomatoes treated with Bacillus subtilus, Bacillus pumilus or both are better than the control group in all three metrics: yields, marketable yield and symptoms of Cmm infections.

Bacillus pumilus and Bacillus subtilus (and a combination of the two) protected tomatoes from Cmm infections, and the cell supernatant composition of the microorganism mixture of IN-M1 provides other benefits as described in in US Publication Nos. 20160100587 and 20160102251, and U.S. Pat. No. 9,175,258, which are incorporated by reference in their entireties herein.

### 5. INCORPORATION BY REFERENCE

All publications, patents, patent applications and other documents cited in this application are hereby incorporated by reference in their entireties for all purposes to the same extent as if each individual publication, patent, patent application or other document were individually indicated to be incorporated by reference for all purposes.

### 6. EQUIVALENTS

While various specific embodiments have been illustrated and described, the above specification is not restrictive. It will be appreciated that various changes can be made without departing from the spirit and scope of the invention(s). Many variations will become apparent to those skilled in the art upon review of this specification.

Sequences

| SEQ ID | | |
|---|---|---|
| NO: | | |
| 1 | 16S rRNA ITI- | GAGCTTGCTCCCGGATGTTAGCGGCGGACGGGTGAGTAACACGTGGGT |
| | 1 | AACCTGCCTGTAAGACTGGGATAACTCCGGGAAACCGGAGCTAATACC |
| | | GGATAGTTCCTTGAACCGCATGGTTCAAGGATGAAAGACGGTTTCGGCT |
| | | GTCACTTACAGATGGACCCGCGGCGCATTAGCTAGTTGGTGAGGTAAC |
| | | GGCTCACCAAGGCGACGATGCGTAGCCGACCTGAGAGGGTGATCGGCC |
| | | ACACTGGGACTGAGACACGGCCCAGACTCCTACGGGAGGCAGCAGTAG |
| | | GGAATCTTCCGCAATGGACGAAAGTCTGACGGAGCAACGCCGCGTGAG |
| | | TGATGAAGGTTTTCGGATCGTAAAGCTCTGTTGTTAGGGAAGAACAAGT |
| | | GCAAGAGTAACTGCTTGCACCTTGACGGTACCTAACCAGAAAGCCACG |
| | | GCTAACTACGTGCCAGCAGCCGCGGTAATACGTAGGTGGCAAGCGTTG |
| | | TCCGGAATTATTGGGCGTAAAGGGCTCGCAGGCGGTTTCTTAAGTCTGA |
| | | TGTGAAAGCCCCCGGCTCAACCGGGGAGGGTCATTGGAAACTGGGAAA |
| | | CTTGAGTGCAGAAGAGGAGAGTGGAATTCCACGTGTAGCGGGAAATG |
| | | CGTAGAGATGTGGAGGAACACCAGTGGCGAAGGCGACTCTCTGGTCTG |
| | | TAACTGACGCTGAGGAGCGAAAGCGTGGGGAGCGAACAGGATTAGATA |
| | | CCCTGGTAGTCCACGCCGTAAACGATGAGTGCTAAGTGTTAGGGGGTTT |
| | | CCGCCCCTTAGTGCTGCAGCTAACGCATTAAGCACTCCGCCTGGGGAGT |
| | | ACGGTCGCAAGACTGAAACTCAAAGGAATTGACGGGGGCCCGCACAAG |
| | | CGGTGGAGCATGTGGTTTAATTCGAAGCAACGCGAAGAACCTTACCAG |
| | | GTCTTGACATCCTCTGACAACCCTAGAGATAGGGCTTTCCCTTCGGGGA |
| | | CAGAGTGACAGGTGGTGCATGGTTGTCGTCAGCTCGTGTCGTGAGATGT |
| | | TGGGTTAAGTCCCGCAACGAGCGCAACCCTTGATCTTAGTTGCCAGCAT |
| | | TCAGTTGGGCACTCTAAGGTGACTGCCGGTGACAAACCGGAGGAAGGT |
| | | GGGGATGACGTCAAATCATCATGCCCCTTATGACCTGGGCTACACACGT |
| | | GCTACAATGGACAGAACAAAGGGCTGCGAGACCGCAAGGTTTAGCCAA |
| | | TCCCACAAATCTGTTCTCAGTTCGGATCGCAGTCTGCAACTCGACTGCG |
| | | TGAAGCTGGAATCGCTAGTAATCGCGGATCAGCATGCCGCGGTGAATA |
| | | CGTTCCCGGGCCTTGTACACACCGCCCGTCACACCACGAGAGTTTGCAA |
| | | CACCCGAAGTCGGTGAGGTAACC |
| 2 | 16S rRNA ITI- | GCAGTCGAGCGGACAGATGGGAGCTTGCTCCCTGATGTTAGCGGCGGA |
| | 2 | CGGGTGAGTAACACGTGGGTAACCTGCCTGTAAGACTGGGATAACTCC |
| | | GGGAAACCGGGGCTAATACCGGATGCTTGTTTGAACCGCATGGTTCAA |
| | | ACATAAAAGGTGGCTTCGGCTACCACTTACAGATGGACCCGCGGCGCA |
| | | TTANNTAGTTGGTGAGGTAACGGCTCACCAAGGCAACGATGCGTAGCC |
| | | GACCTGAGAGGGTGATCGGCCACACTGGGACTGAGACACGGCCCAGAC |
| | | TCCTACGGGAGGCAGCAGTAGGGAATCTTCCGCAATGGACGAAAGTCT |
| | | GACGGAGCAACGCCGCGTGAGTGATGAAGGTTTTCGGATCGTAAAGCT |
| | | CTGTTGTTAGGGAAGAACAAGTACCGTTCGAATAGGGCGGTACCTTGA |
| | | CGGTACCTAACCAGAAAGCCACGGCTAACTACGTGCCAGCAGCCGCGG |
| | | TAATACGTAGGTGGCAAGCGTTGTCCGGAATTATTGGGCGTAAAGGGC |
| | | TCGCAGGCGGTTTCTTAAGTCTGATGTGAAAGCCCCCGGCTCAACCGGG |
| | | GAGGGTCATTGGAAACTGGGGAACTTGAGTGCAGAAGAGGAGAGTGG |
| | | AATTCCACGTGAGCGGTGAAATGCGTAGAGATGTGGAGGAACACCAG |
| | | TGGCGAAGGCGACTCTCTGGTCTGTAACTGACGCTGAGGAGCGAAAGC |
| | | GTGGGGAGCGAACAGGATTAGATACCCTGGTAGTCCACGCCGTAAACG |
| | | ATGAGTGCTAAGTGTTAGGGGGTTTCCGCCCCTTAGTGCTGCAGCTAAC |
| | | GCATTAAGCACTCCGCCTGGGGAGTACGGTCGCAAGACTGAAACTCAA |
| | | AGGAATTGACGGGGGCCCGCACAAGCGGTGGAGCATGTGGTTTAATTC |
| | | GAAGCAACGCGAAGAACCTTACCAGGTCTTGACATCCTCTGACAATCCT |
| | | AGAGATAGGACGTCCCCTTCGGGGGCAGAGTGACAGGTGGTGCATGGT |
| | | TGTCGTCAGCTCGTGTCGTGAGATGTTGGGTTAAGTCCCGCAACGAGCG |
| | | CAACCCTTGATCTTAGTTGCCAGCATTCAGTTGGGCACTCTAAGGTGAC |
| | | TGCCGGTGACAAACCGGAGGAAGGTGGGGATGACGTCAAATCATCATG |
| | | CCCCTTATGACCTGGGCTACACACGTGCTACAATGGACAGAACAAAGG |
| | | GCAGCGAAACCGCGAGGTTAAGCCAATCCCACAAATCTGTTCTCAGTTC |
| | | GGATCGCAGTCTGCAACTCGACTGCGTGAAGCTGGAATCGCTAGTAATC |
| | | GCGGATCAGCATGCCGCGGTGAATACGTTCCCGGGCCTTGTACACACCG |
| | | CCCGTCACACCACGAGAGTTTGTAACACCCGAAGTCGGTGAGGTAACC |
| 3 | 16S rRNA ITI- | TAGTTGGTGAGGTAACGGCTCACCAAGGCAACGATGCGTAGCCGACCT |
| | 3 | GAGAGGGTGATCGGCCACACTGGGACTGAGACACGGCCCAGACTCCTA |
| | | CGGGAGGCAGCAGTAGGGAATCTTCCGCAATGGACGAAAGTCTGACGG |
| | | AGCAACGCCGCGTGAGTGATGAAGGTTTTCGGATCGTAAAGCTCTGTTG |
| | | TTAGGGAAGAACAAGTACCGTTCGAATAGGGCGGTACCTTGACGGTAC |
| | | CTAACCAGAAAGCCACGGCTAACTACGTGCCAGCAGCCGCGGTAATAC |
| | | GTAGGTGGCAAGCGTTGTCCGGAATTATTGGGCGTAAAGGGCTCGCAG |
| | | GCGGTTTCTTAAGTCTGATGTGAAAGCCCCCGGCTCAACCGGGGAGGGT |
| | | CATTGGAAACTGGGGAACTTGAGTGCAGAAGAGGAGAGTGGAATTCCA |
| | | CGTGTAGCGGTGAAATGCGTAGAGATGTGGAGGAACACCAGTGGCGAA |
| | | GGCGACTCTCTGGTCTGTAACTGACGCTGAGGAGCGAAAGCGTGGGGA |
| | | GCGAACAGGATTAGATACCCTGGTAGTCCACGCCGTAAACGATGAGTG |
| | | CTAAGTGTTAGGGGGTTTCCGCCCCTTAGTGCTGCAGCTAACGCATTAA |
| | | GCACTCCGCCTGGGGAGTACGGTCGCAAGACTGAAACTCAAAGGAATT |
| | | GACGGGGGCCCGCACAAGCGGTGGAGCATGTGGTTTAATTCGAAGCAA |
| | | CGCGAAGAACCTTACCAGGTCTTGACATCCTCTGACAATCCTAGAGATA |
| | | GGACGTCCCCTTCGGGGGCAGAGTGACAGGTGGTGCATGGTTGTCGTC |
| | | AGCTCGTGTCGTGAGATGTTGGGTTAAGTCCCGCAACGAGCGCAACCCT |
| | | TGATCTTAGTTGCCAGCATTCAGTTGGGCACTCTAAGGTGACTGCCGGT |
| | | GACAAACCGGAGGAAGGTGGGGATGACGTCAAATCATCATGCCCCTTA |
| | | TGACCTGGGCTACACACGTGCTACAATGGACAGAACAAAGGGCAGCGA |
| | | AACCGCGAGGTTAAGCCAATCCCACAAATCTGTTCTCAGTTCGGATCGC |
| | | AGTCTGCAACTCGACTGCGTGAAGCTGGAATCGCTAGTAATCGCGGATC |
| | | AGCATGCCGCGGTGAATACGTTCCCGGGCCTTGTACACACCGCCCGTCA |
| | | CACCACGAGAGTTTGTAACACCCGAAGTCGGTGAGGTAACC |
| 4 | Bacillus | GTGCGGGTGCTATAATGCAGTCGAGCGGACAGAAGGGAGCTTGCTCCC |
| | pumilus strain | GGATGTTAGCGGCGGACGGGTGAGTAACACGTGGGTAACCTGCCTGTA |
| | NES-CAP-1 | AGACTGGGATAACTCCGGGAAACCGGAGCTAATACCGGATAGTTCCTT |
| | (GenBank | GAACCGCATGGTTCAAGGATGAAAGACGGTTTCGGCTGTCACTTACAG |
| | Accession No. | ATGGACCCGCGGCGCATTAGCTAGTTGGTGAGGTAACGGCTCACCAAG |
| | MF079281.1) | GCGACGATGCGTAGCCGACCTGAGAGGGTGATCGGCCACACTGGGACT |
| | | GAGACACGGCCCAGACTCCTACGGGAGGCAGCAGTAGGGAATCTTCCG |
| | | CAATGGACGAAAGTCTGACGGAGCAACGCCGCGTGAGTGATGAAGGTT |
| | | TTCGGATCGTAAAGCTCTGTTGTTAGGGAAGAACAAGTGCAAGAGTAA |
| | | CTGCTTGCACCTTGACGGTACCTAACCAGAAAGCCACGGCTAACTACGT |
| | | GCCAGCAGCCGCGGTAATACGTAGGTGGCAAGCGTTGTCCGGAATTAT |
| | | TGGGCGTAAAGGGCTCGCAGGCGGTTTCTTAAGTCTGATGTGAAAGCCC |
| | | CCGGCTCAACCGGGGAGGGTCATTGGAAACTGGGAAACTTGAGTGCAG |
| | | AAGAGGAGAGTGGAATTCCACGTGTAGCGGTGAAATGCGTAGAGATGT |
| | | GGAGGAACACCAGTGGCGAAGGCGACTCTCTGGTCTGTAACTGACGCT |
| | | GAGGAGCGAAAGCGTGGGGAGCGAACAGGATTAGATACCCTGGTAGTC |
| | | CACGCCGTAAACGATGAGTGCTAAGTGTTAGGGGGTTTCCGCCCCTTAG |
| | | TGCTGCAGCTAACGCATTAAGCACTCCGCCTGGGGAGTACGGTCGCAA |
| | | GACTGAAACTCAAAGGAATTGACGGGGGCCCGCACAAGCGGTGGAGCA |
| | | TGTGGTTTAATTCGAAGCAACGCGAAGAACCTTACCAGGTCTTGACATC |
| | | CTCTGACAACCCTAGAGATAGGGCTTTCCCTTCGGGGACAGAGTGACA |
| | | GGTGGTGCATGGTTGTCGTCAGCTCGTGTCGTGAGATGTTGGGTTAAGT |
| | | CCCGCAACGAGCGCAACCCTTGATCTTAGTTGCCAGCATTCAGTTGGGC |
| | | ACTCTAAGGTGACTGCCGGTGACAAACCGGAGGAAGGTGGGGATGACG |
| | | TCAAATCATCATGCCCCTTATGACCTGGGCTACACACGTGCTACAATGG |
| | | ACAGAACAAAGGGCTGCGAGACCGCAAGGTTTAGCCAATCCCACAAAT |
| | | CTGTTCTCAGTTCGGATCGCAGTCTGCAACTCGACTGCGTGAAGCTGGA |
| | | ATCGCTAGTAATCGCGGATCAGCATGCCGCGGTGAATACGTTCCCGGGC |
| | | CTTGTACACACCGCCCGTCACACCACGAGAGTTTGCAACACCCGAAGTC |
| | | GGTGAGGTAACCTTTATGGAGCCAGCCGCCGAACGTTC |
| 5 | Bacillus subtilis | TGGCGGCGTGCTATAATGCAGTCGAGCGGACAGATGGGAGCTTGCTCC |
| | strain | CTGATGTTAGCGGCGGACGGGTGAGTAACACGTGGGTAACCTGCCTGT |
| | BSFLG01 | AAGACTGGGATAACTCCGGGAAACCGGGGCTAATACCGGATGCTTGTT |
| | (GenBank | TGAACCGCATGGTTCAAACATAAAAGGTGGCTTCGGCTACCACTTACAG |
| | Accession No. | ATGGACCCGCGGCGCATTAGCTAGTTGGTGAGGTAACGGCTCACCAAG |
| | MF196314.1) | GCAACGATGCGTAGCCGACCTGAGAGGGTGATCGGCCACACTGGGACT |
| | | GAGACACGGCCCAGACTCCTACGGGAGGCAGCAGTAGGGAATCTTCCG |
| | | CAATGGACGAAAGTCTGACGGAGCAACGCCGCGTGAGTGATGAAGGTT |
| | | TTCGGATCGTAAAGCTCTGTTGTTAGGGAAGAACAAGTACCGTTCGAAT |
| | | AGGGCGGTACCTTGACGGTACCTAACCAGAAAGCCACGGCTAACTACG |
| | | TGCCAGCAGCCGCGGTAATACGTAGGTGGCAAGCGTTGTCCGGAATTA |
| | | TTGGGCGTAAAGGGCTCGCAGGCGGTTTCTTAAGTCTGATGTGAAAGCC |
| | | CCCGGCTCAACCGGGGAGGGTCATTGGAAACTGGGGAACTTGAGTGCA |
| | | GAAGAGGAGAGTGGAATTCCACGTGTAGCGGTGAAATGCGTAGAGATG |
| | | TGGAGGAACACCAGTGGCGAAGGCGACTCTCTGGTCTGTAACTGACGC |
| | | TGAGGAGCGAAAGCGTGGGGAGCGAACAGGATTAGATACCCTGGTAGT |
| | | CCACGCCGTAAACGATGAGTGCTAAGTGTTAGGGGGTTTCCGCCCCTTA |
| | | GTGCTGCAGCTAACGCATTAAGCACTCCGCCTGGGGAGTACGGTCGCA |
| | | AGACTGAAACTCAAAGGAATTGACGGGGGCCCGCACAAGCGGTGGAGC |
| | | ATGTGGTTTAATTCGAAGCAACGCGAAGAACCTTACCAGGTCTTGACAT |
| | | CCTCTGACAATCCTAGAGATAGGACGTCCCCTTCGGGGGCAGAGTGAC |
| | | AGGTGGTGCATGGTTGTCGTCAGCTCGTGTCGTGAGATGTTGGGTTAAG |
| | | TCCCGCAACGAGCGCAACCCTTGATCTTAGTTGCCAGCATTCAGTTGGG |
| | | CACTCTAAGGTGACTGCCGGTGACAAACCGGAGGAAGGTGGGGATGAC |
| | | GTCAAATCATCATGCCCCTTATGACCTGGGCTACACACGTGCTACAATG |
| | | GACAGAACAAAGGGCAGCGAAACCGCGAGGTTAAGCCAATCCCACAA |
| | | ATCTGTTCTCAGTTCGGATCGCAGTCTGCAACTCGACTGCGTGAAGCTG |
| | | GAATCGCTAGTAATCGCGGATCAGCATGCCGCGGTGAATACGTTCCCG |
| | | GGCCTTGTACACACCGCCCGTCACACCACGAGAGTTTGTAACACCCGAA |
| | | GTCGGTGAGGTAACCTTTTAGGAGCCAGCCGCCGAAGGGACAGAGAG |
| 6 | Bacillus subtilis | CTGGCTCAGGACGAACGCTGGCGGCGTGCCTAATACATGCAAGTCGAG |
| | strain SSL2 | CGGACAGATGGGAGCTTGCTCCCTGATGTTAGCGGCGGACGGGTGAGT |
| | (GenBank | AACACGTGGGTAACCTGCCTGTAAGACTGGGATAACTCCGGGAAACCG |
| | Accession No. | GGGCTAATACCGGATGGTTGTTTGAACCGCATGGTTCAAACATAAAAG |
| | MH192382.1) | GTGGCTTCGGCTACCACTTACAGATGGACCCGCGGCGCATTAGCTAGTT |
| | | GGTGAGGTAACGGCTCACCAAGGCAACGATGCGTAGCCGACCTGAGAG |
| | | GGTGATCGGCCACACTGGGACTGAGACACGGCCCAGACTCCTACGGGA |
| | | GGCAGCAGTAGGGAATCTTCCGCAATGGACGAAAGTCTGACGGAGCAA |
| | | CGCCGCGTGAGTGATGAAGGTTTTCGGATCGTAAAGCTCTGTTGTTAGG |
| | | GAAGAACAAGTACCGTTCGAATAGGGCGGTACCTTGACGGTACCTAAC |
| | | CAGAAAGCCACGGCTAACTACGTGCCAGCAGCCGCGGTAATACGTAGG |
| | | TGGCAAGCGTTGTCCGGAATTATTGGGCGTAAAGGGCTCGCAGGCGGT |
| | | TTCTTAAGTCTGATGTGAAAGCCCCCGGCTCAACCGGGGAGGGTCATTG |
| | | GAAACTGGGGAACTTGAGTGCAGAAGAGGAGAGTGGAATTCCACGTGT |
| | | AGCGGTGAAATGCGTAGAGATGTGGAGGAACACCAGTGGCGAAGGCG |
| | | ACTCTCTGGTCTGTAACTGACGCTGAGGAGCGAAAGCGTGGGGAGCGA |
| | | ACAGGATTAGATACCCTGGTAGTCCACGCCGTAAACGATGAGTGCTAA |
| | | GTGTTAGGGGGTTTCCGCCCCTTAGTGCTGCAGCTAACGCATTAAGCAC |
| | | TCCGCCTGGGGAGTACGGTCGCAAGACTGAAACTCAAAGGAATTGACG |
| | | GGGGCCCGCACAAGCGGTGGAGCATGTGGTTTAATTCGAAGCAACGCG |
| | | AAGAACCTTACCAGGTCTTGACATCCTCTGACAATCCTAGAGATAGGAC |
| | | GTCCCCTTCGGGGGCAGAGTGACAGGTGGTGCATGGTTGTCGTCAGCTC |
| | | GTGTCGTGAGATGTTGGGTTAAGTCCCGCAACGAGCGCAACCCTTGATC |
| | | TTAGTTGCCAGCATTCAGTTGGGCACTCTAAGGTGACTGCCGGTGACAA |
| | | ACCGGAGGAAGGTGGGGATGACGTCAAATCATCATGCCCCTTATGACC |
| | | TGGGCTACACACGTGCTACAATGGACAGAACAAAGGGCAGCGAAACCG |
| | | CGAGGTTAAGCCAATCCCACAAATCTGTTCTCAGTTCGGATCGCAGTCT |
| | | GCAACTCGACTGCGTGAAGCTGGAATCGCTAGTAATCGCGGATCAGCA |
| | | TGCCGCGGTGAATACGTTCCCGGGCCTTGTACACACCGCCCGTCACACC |
| | | ACGAGAGTTTGTAACACCCGAAGTCGGTGAGGTAACCTTTTAGGAGCC |
| | | AGCCGCCGAAGGTGGGACAGATGATTGGGGTGAAGTCGTAACAAGGTA |
| | | GCCGTATCGGAAGGTGCGGTTGGAT |
| 7 | 136 bp PCR | GGTTCTCCGCATCAAACTATCCGGCGAACTTGCCGGGTATTTGGGACGC |
| | product from | CCACTGGGGATACCTGGCGAAGAAGGACATTGCCCCGGTTCTCGTGGG |
| | Cmm | TGAGTTCGGTACGAAGTTCGAGACGACGAGCGACAAGCA |
| 8 | Clavibacter | GTGCGAAAGGCGTCTGTGGAAGTGGTTTTCAGTGCGGCCGGATGGCTTC |
| | michiganensis | CCTACGATCCTTATATGACATTTCGCCAAGTTCGTGCATCCTTAGTGCTT |
| | subsp. | CGGCTCGTCCTTCTCCTTGCGTTGGTGGTCGGCACCACGTCCGCCGCATT |
| | michiganensis | CGCTGCGCCTGTCTCAGCCGCCACCGTAGCGGGGCCCGTTGCGGCGGCC |
| | CelA gene, | TCATCGCCTGGATGGCTGCATACGGCGGGCGGGAAGATCGTCACCGCC |
| | complete cds | TCCGGTGCTCCGTACACGATCCGTGGCATCGCTTGGTTTGGCATGGAGA |
| | (GenBank | CGTCGTCGTGCGCGCCGCATGGCCTGGACACCATCACCCTCGCGGGCGG |
| | Accession No: | TATGCAGCACATCAAGCAGATGGGGTTCACGACCGTGCGGTTGCCCTTC |
| | KJ123730.1) | TCGAACCAGTGCCTCGCCGCGTCCGGCGTCACGGGTGTCAGTGCGGACC |
| | | CGTCACTCGCCGGGCTCACGCCGCTGCAGGTCATGGACCACGTCGTCGC |
| | | GTCGGCGAAGAGCGCCGGTCTTGACGTGATCCTCGACCAGCACCGGCC |
| | | GGACTCGGGCGGCCAGTCTGAGCTCTGGTACACATCGCAGTATCCGGA |
| | | GTCGCGGTGGATCTCCGACTGGAGGATGCTCGCAAAGCGCTACGCGTC |
| | | CGACCCCGCCGTCATCGGTGTCGACCTGCACAACGAGCCGCACGGTGC |
| | | GGCGACCTGGGGTACCGGGGCGGCCACCACTGACTGGCGGGCAGCGGC |
| | | CGAGCGTGGCGGGAATGCGGTCCTCGCCGAGAACCCGAACCTCCTCGT |
| | | GCTCGTGGAGGGCATCGACCACGAGGCCGACGGATCTGGCACCTGGTG |
| | | GGGCGGCGCGCTCGGGTTGGTAGGCAATGCACCTGTGCGGCTGTCGGT |
| | | CGCGAATCGCGTCGTCTACTCCCCGCATGACTACCCCTCGACCATTTAC |
| | | GGCCAGTCATGGTTCTCCGCATCAAACTATCCGGCGAACTTGCCGGGTA |
| | | TTTGGGACGCCCACTGGGGATACCTGGCGAAGAAGGACATTGCCCCGG |
| | | TTCTCGTGGGTGAGTTCGGTACGAAGTTCGAGACGACGAGCGACAAGC |
| | | AGTGGCTCAACACCCTCGTTGGATATCTGTCGAGCACGGGGATTAGCTC |
| | | GTCGTTCTGGGCCTTCAACCCGAATAGTGGCGACACCGGCGGTATCGTG |
| | | AAGTCCGACTGGGTGACCCCGGAGCAGGCGAAGCTCGACGCCCTGGCG |
| | | CCGATCTTGCACCCGTCGCCCGGGTCGGGTCCGGGATCCGGCGGATCCG |
| | | GGTCTCAGCCAGCGCCGCAGCCCGATCCGGCGAACCCGGGCGCTGTAT |
| | | CAGCGAAGTGGCAGCCTGGCAGCTCCTGGGCATCGGGCTACGTAGCGA |
| | | ACATCGACGTCACCGCGACAGCCGCTGTCACGGGATGGACCGTCTCAT |
| | | GGGCCAGCCCCGGAACCACCCGCGTCGTCAACAGTTGGGGCATGCGCT |
| | | GCAGCGTCGCCTCCGGCACCGTGAGCTGCACCGGCACGGACTGGGCGA |
| | | GCAAGCTCGCCGCCGGCCAGACCGTTCACGTCGGCCTACAGGCGTCGG |
| | | GTGGCCCGGCTCCCTCTTCACCACGACTCACCGCTACAGCGGCCGCGGT |
| | | GCCGCCTGCCCAGCCCACACCGCCCGCTCGGCCCACGACGCATGGCCGT |
| | | GCCACGCACTACTCGCTCGGCCAGGGCAACACGATCGCGAACGGCAAC |
| | | TGCTCCATGCCGGCTGTCCCTGCAGACCGAATGTACGTTGCGGTCAGCA |
| | | GCCCCGAGTACAGCGGTGCCGCCGCGTGCGGCACCTTCCTCGACGTCAC |
| | | TGGCCCCAAGGGCACCGTCCGCGTTCAGGTCGCTGACCAGTGCCATGG |
| | | GTGCGAGGTCGGACATCTCGATCTGAGCGAGGAAGCGTTCCGCGCCCT |
| | | CGGCGACTTCAATGCCGGCATCATCCCGATCAGCTACGTCACCGTCCGG |
| | | GATCCGGCCGGGCCTACCGTCGCCATCCGAGTCAAAGAAGGCTCATCC |
| | | CGCTGGTGGGCAGGTCTGCAGGTCCTGAACGCCGGCAACCGCATTGAC |
| | | CGTGTCGAAATCCAGGCCGGGAGACAGTGGCTGCCCCTCACTCGCACC |
| | | GACTACGGGTACTGGGTGACGCCGTCCCCGATTCAGGACGGCCCCCTG |
| | | ACCGTGAAGGTGACCGACCAGTATGGTCGCGCGGTCGTGCTCCCCGGC |
| | | CTCCGCATGGCACCCGGGGAGATCCAGCGCACGGCCTCCCGCTTCTACC |
| | | CTGTGCACTGA |

1. A method of controlling, suppressing and/or preventing an infection from Clavibacter michiganensis subsp. michiganensis (Cmm) in tomatoes, comprising:
providing an antimicrobial composition comprising at least one of Bacillus pumilus strain, a culture medium inoculated with Bacillus pumilus, a cell-free extract of Bacillus pumilus or at least one metabolite of Bacillus pumilus, and
applying an effective amount of said antimicrobial composition to at least one of a tomato plant, a tomato root, a tomato leaf, a tomato fruit and a tomato stem.

2-6. (canceled)

7. The method of claim 1, wherein the antimicrobial composition comprises Micrococcin P1.

8. (canceled)

9. The method of claim 7, wherein the Micrococcin P1 is produced by the Bacillus pumilus.

10. The method of claim 1, wherein the antimicrobial composition further comprises a filtered fraction and/or a cell free supernatant of a microorganism mixture comprising Lactobacillus paracasei, Lactobacillus helveticus, Lactobacillus plantarum, Lactobacillus rhamnosus, Lactococcus lactis, Bacillus amyloliquefaciens, Aspergillus oryzae, Saccharomyces cerevisiae, Candida utilis, and Rhodopseudomonas palustris, or a mixture thereof.

11-39. (canceled)

40. A composition for the bioprotection of tomatoes from Clavibacter michiganensis subsp. michiganensis (Cmm), comprising:
an effective amount of Micrococcin P1; and
an agriculturally acceptable carrier,
wherein said composition is formulated for application to at least one of a tomato plant, a tomato root, a tomato leaf, a tomato seed and a tomato stem; and
wherein said Micrococcin P1 is effective in controlling, suppressing and/or preventing infection from Cmm.

41. (canceled)

42. The composition of claim 40, wherein the Micrococcin P1 is produced by Bacillus pumilus.

43-48. (canceled)

49. The composition of claim 40, further comprising a cell-free supernatant and/or a filtered fraction of a microbial culture inoculated with one or more of Lactobacillus paracasei, Lactobacillus helveticus, Lactobacillus plantarum, Lactobacillus rhamnosus, Lactococcus lactis, Bacillus amyloliquefaciens, Aspergillus oryzae, Saccharomyces cerevisiae, Candida utilis, and Rhodopseudomonas palustris.

50-54. (canceled)

55. A method of protecting tomatoes from Clavibacter michiganensis subsp. michiganensis (Cmm), comprising the step of:
applying an effective amount of the composition of claim 40 to a tomato plant, a tomato root, a tomato leaf, a tomato seed and/or a tomato stem,
wherein the effective amount is sufficient for bioprotection of the tomato plant from Cmm.

56. The method of claim 1,
wherein said method provides for bioprotection against Cmm;
wherein said bioprotection comprises at least one of enhancing resistance against Cmm, reducing damage caused by Cmm, enhancing plant antimicrobial response against Cmm, increasing plant antinematocidal activity, reducing pathological symptoms or lesions resulting from actions of Cmm, and increasing tomatoes yield; and
wherein said bioprotection is determined by comparing damages of tomatoes contacted or not with said antimicrobial composition.

57. The method of claim 1, wherein said Bacillus pumilus strain comprises a 16S rRNA having at least 95% identity with SEQ ID NO: 4.

58. The method of claim 1, wherein the at least one Bacillus pumilus strain comprises ATCC® Patent Designation No. PTA-125304 and/or NES-CAP-1 (GenBank Accession No. MF079281.1).

59. The method of claim 1, wherein said antimicrobial composition further comprises at least one strain of Bacillus subtilis, a culture medium inoculated with Bacillus subtilis, a cell-free extract of Bacillus subtilis or at least one metabolite of Bacillus subtilis.

60. The method of claim 1, wherein said antimicrobial composition further comprises at least one of an herbicide, an insecticide, a fungicide and a nutrient.

61. The composition of claim 40, further comprising at least one strain of Bacillus subtilis, a culture medium inoculated with Bacillus subtilis, a cell-free extract of Bacillus subtilis or at least one metabolite of Bacillus subtilis.

62. The composition of claim 42, wherein said Bacillus pumilus comprises a 16S rRNA having at least 95% identity with SEQ ID NO: 4.

63. The composition of claim 42, wherein said Bacillus pumilus comprises ATCC® Patent Designation No. PTA-125304 and/or NES-CAP-1 (GenBank Accession No. MF079281.1).
